(19) United States
(12) Patent Application Publication
(10) Pub. No.: US 2003/0172007 A1
(43) Pub. Date: Sep. 11, 2003

(54) Supply chain fulfillment coordination

(76) Inventors: Hans-Ulrich Von Helmolt, Heidelberg (DE); Jochen Hirth, Brikenau (DE); Thomas Kalle, Saarburg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/208,200

(22) Filed: Jul. 31, 2002

Related U.S. Application Data
(60) Provisional application No. 60/362,382, filed on Mar. 6, 2002.

(51) Int. Cl. G06F 17/60

(52) U.S. Cl. 705/28

(57) ABSTRACT

A system includes one or more computer systems and a fulfillment coordination computer coupled to the computer systems over a network. The fulfillment coordination computer is operable to receive an order, use a first set of rules to split the order into one or more work packages necessary to fulfill the order, and use a second set of rules to assign the work packages to one or more partners.

### RELATED APPLICATIONS

This application claims priority from U.S. Provisional Application Serial No. 60/362,382, filed Mar. 6, 2002 and titled Supply Chain Fulfillment Coordination, the contents of which are incorporated herein by reference.

### TECHNICAL FIELD

This invention relates to supply chain management and, more particularly, to order fulfillment coordination in a supply chain.

### BACKGROUND

The Internet and the continuously evolving business relationships are dramatically changing the way that companies interact. From the old days of a closed enterprise that kept all activities in its hand, a new path leads to a network of relationships that replaces classical linear links. The links in the network of relationships exist inside one enterprise as well as beyond the boundaries of the company. The network itself is not fixed but shaped by a dynamic environment, thus, the structure may change very rapidly. New partners and business processes have to be integrated very fast and resulting from that change, an always new network of relationships evolves. The processes inside the network have to be very adaptive to exceptions and unexpected events.

Such a dynamic structure of an enterprise that is built by the redefinition of business processes in the Internet demands an open, flexible reacting and adaptable structure for logistical processes. The central question to be answered in the complex network is: who should do what and when during a given process to satisfy the customer's need in the best way? The transition from solely enterprise-based planning and execution to a networked structure can happen step-by-step or in a big bang, e.g., as a result of a company's merger. In both cases, there is a demand for coordinating the complex interplay of different—internal or external—partners. The complexity of the networked and dynamic adaptive structures can be viewed or defined using different scenarios.

One such scenario is a merger between companies, which leads to synergies by enhancing or deepening the product offering. A horizontal merger between companies present in the same market may have no impact for the customer viewing the companies. Both companies are still present on the market and are recognized independently. Synergies result from logistical processing (e.g., a combined logistics process with different sales channels needs the coordination of logistics activities). A vertical merger enables sales synergies. The product portfolio is enriched if together with the product offerings, the company offers an additional product or service.

Occasionally, a supply chain will be restructured to emphasize core competences in which each partner in the value generation process contributes that which it can produce best. The “manufacturer” of a computer may only take on marketing and development of the devices—actual production and logistical and distribution activities can be addressed to other partners in the supply chain. Even with the work distributed between partners and the manufacturer, the manufacturer may yet retain control over the complete process and coordinate the process.

Another result of evolving business relationships is outsourcing, which involves an allocation of singular activities to external partners or a management of areas of the company as cost centers as a consequence of focusing on core competences. To the process flow, it is irrelevant who actually brings the actual service. Instead, the importance is in consolidating results to design a process to be more efficient. The extent of outsourcing is variable. Enterprise processes can be made independent and brought by internal or external partners.

All scenarios require a coordination of processes that is open to integrate partners. The coordination must be flexible and adaptive to react to different situations. In the end, the coordination of a complex network must be alterable to include new processes. Ideally, the coordination should become similar to an integration hub, such as a private exchange, where all partners meet to exchange information and integrate sales and logistics processes.

### SUMMARY

In one general aspect, coordinating the fulfillment of an order includes receiving an order, using a first set of rules to split the order into one or more work packages necessary to fulfill the order, and using a second set of rules to assign the work packages to one or more partners.

Embodiments of the method of coordinating the fulfillment of an order may include one or more of the following features. For example, the first set of rules may break the order into one or more work packages based on the locations of goods necessary to fulfill the order. The first set of rules also may break the order into one or more work packages based on the locations in which the order is to be fulfilled. The coordination may further include consolidating goods by obtaining goods from each of the partners to which a work package is assigned. The coordination may further include shipping the consolidated goods to the sender of the order.

The coordination may further include receiving a notification from one or more of the partners. Receiving a notification may include receiving a notification of one or more of a shipping notification and a transport notification.

The coordination may further include receipt of goods when the order comprises an inbound delivery. The coordination may further include providing data to one or more of a warehouse management system and an inventory management system.

The coordination may further include calculating a logistics cost of fulfilling the order.

In another general aspect, an article includes a computer-readable medium that stores executable instructions for causing a computer system to receive an order, use a first set of rules to split the order into one or more work packages necessary to fulfill the order, and use a second set of rules to assign the work packages to one or more partners.

Embodiments of the article may include one or more of the following features. For example, the first set of rules may include instructions to break the order into one or more work packages based on the locations of goods necessary to fulfill the order. The first set of rules may include instructions to break the order into one or more work packages based on the locations in which the order is to be fulfilled.

The article may further include executable instructions for causing the computer system to cause a consolidation of goods by obtaining goods from each of the partners to which a work package is assigned. The article may further include executable instructions for causing the computer system to cause the shipping of the consolidated goods to the sender of the order.

The article may further include executable instructions for causing the computer system to receive a notification from one or more of the partners. The notification may include one or more of a shipping notification and a transport notification.

The article may further include executable instructions for causing the computer system to provide a receipt of goods when the order comprises an inbound delivery, and may further include executable instructions for causing the computer system to provide data to one or more of a warehouse management system and an inventory management system.

The article may still further include executable instructions for causing the computer system to calculate a logistics cost of fulfilling the order.

In another general aspect, a system includes one or more computer systems and a fulfillment coordination computer coupled to the computer systems over a network. The fulfillment coordination computer is operable to receive an order, use a first set of rules to split the order into one or more work packages necessary to fulfill the order, and use a second set of rules to assign the work packages to one or more partners.

Embodiments of the system may include one or more of the following features. For example, the first set of rules may include instructions to break the order into one or more work packages based on the locations of goods necessary to fulfill the order. The first set of rules may include instructions to break the order into one or more work packages based on the locations in which the order is to be fulfilled.

The system may include executable instructions to cause a consolidation of goods by obtaining goods from each of the partners to which a work package is assigned. The system may further include executable instructions for causing the shipping of the consolidated goods to the sender of the order.

The system may further include executable instructions for causing the fulfillment coordination computer to receive a notification from one or more of the partners. The notification may include one or more of a shipping notification and a transport notification.

The system may further include executable instructions for causing the fulfillment coordination computer to provide a receipt of goods when the order comprises an inbound delivery. The system may further include executable instructions for causing the fulfillment coordination computer to provide data to one or more of a warehouse management system and an inventory management system.

The system may still further include executable instructions for causing the fulfillment coordination computer to calculate a logistics cost of fulfilling the order.

The article and system may be implemented with a fulfillment coordination engine, and provide considerable advantages to industries. For example, high tech industries are moving from a make-to-forecast orientation to a make-to-order and configure-to-order orientation, which can be controlled using the fulfillment coordination engine to optimize dynamic sourcing and logistics management. Moreover, because high tech industries often have complex product variant structures, the fulfillment coordination engine can be used to advantageously automate the fulfillment of orders for those complex products.

Automotive companies also can benefit from implementing a fulfillment coordination engine because the manufacture of cars and trucks involves a large number of consigned component suppliers that are integrated into the order fulfillment process. Integration of the suppliers and third party logistics providers enables fast order fulfillment. Consumer packed goods (“CPG”) suppliers and logistics service providers also benefit from using the fulfillment coordination engine. There are many CPG suppliers that often have experience with collaborative planning, forecasting, and replenishment initiatives. As such, the CPG suppliers are likely to be receptive to a fulfillment coordination engine. Logistics service providers operate across distributed fulfillment networks and are familiar with the need to coordinate fulfillment of many products from multiple customer while at the same time not owning these products.

The details of one or more embodiments of the invention are set forth in the accompanying drawings and description. Other features, objects, and advantages of the invention will be apparent from the description, the drawings, and the claims.

### DESCRIPTION OF DRAWINGS

FIG. 1 is a flow chart illustrating the operation of a fulfillment coordination engine.

FIG. 2 is a flow chart illustrating the operation of a fulfillment coordination engine to an outbound scenario.

FIG. 3 is a flow chart illustrating the operation of a fulfillment coordination engine to a cross docking scenario.

FIG. 4 illustrates a fulfillment coordination engine used to provide bare routing services.

FIG. 5 is a plan view illustrating an exemplary use of the fulfillment coordination engine of FIG. 4.

FIG. 6 illustrates a fulfillment coordination engine that is linked to multiple execution partners and a sales organization

FIG. 7 illustrates a fulfillment coordination engine that is linked to multiple internal and external execution partners.

FIG. 8 illustrates a fulfillment coordination engine that is linked to multiple internal and external execution partners to process numerous input requests.

FIG. 9 illustrates the exchange infrastructure architecture for the design of a fulfillment coordination engine.

FIG. 10 illustrates the message flow from a sender of a message to a recipient of the message using a fulfillment coordination engine.

FIG. 11 illustrates the implementation of a fulfillment coordination engine with a distributed order management scenario in an existing business application.

FIG. 12 illustrates a high level arrangement of a distributed order management scenario for fulfilling orders.

FIG. 13 illustrates an enterprise-centric arrangement of an order fulfillment system.

FIG. 14 illustrates a customer-centric arrangement of an order fulfillment system.

FIG. 15 illustrates an implementation of a fulfillment coordination engine for providing distributed order management fulfillment of a customer order.

FIGS. 16 and 17 illustrate an intra-company distributed order management system.

FIGS. 18 and 19 illustrate an intra-enterprise distributed order management system.

FIGS. 20 and 21 illustrate the intra-enterprise distributed order management system of FIG. 18 with the inclusion of a fulfillment coordination engine.

FIG. 22 illustrates a fulfillment coordination engine that is a component of an adaptive supply chain network.

FIGS. 23 and 24 illustrate implementations of fulfillment coordination engines as part of corporate systems for order fulfillment.

FIG. 25 illustrates a specific single supply chain management system used to direct networking, planning, coordination, and execution of an order.

FIG. 26 illustrates a specific supply chain management system that includes message-based integration.

Like reference symbols in the various drawings indicate like elements.

### DETAILED DESCRIPTION

A fulfillment coordination engine or system is used to coordinate the fulfillment of an order placed with a company by an originator of an order. The originator of the order may be, for example, an internal originator within the company or an external originator from another entity. In general, the fulfillment coordination engine: (1) receives the order; (2) breaks the order into one or more work packages; (3) determines whether the order should be fulfilled entirely within the organization of the recipient of the order and/or by using external organizations entirely or in part; and (4) assigns the work packages to respective partners. Other specific details of the fulfillment coordination engine are described in more detail below.

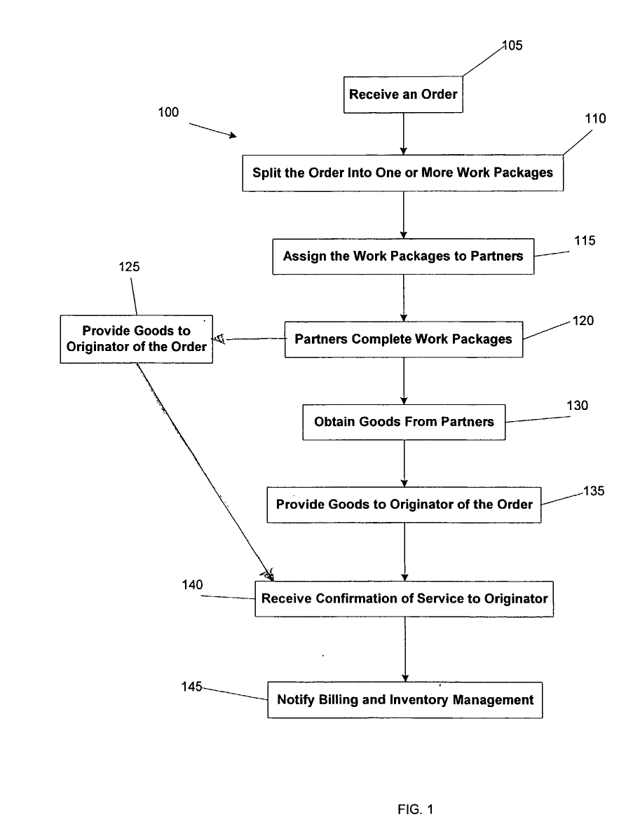

Referring to FIG. 1, a method of fulfilling an order 100 uses a fulfillment coordination engine. Initially, a company receives an order 100 from an originator of the order (step 105). The originator of the order can be an entirely different entity or company. Alternatively, the originator of the order can be a department, division, or other entity within the company. The order can be for an inbound order or an outbound order. An inbound order is, for example, the return of goods from one or more stores, a warehouse, a customs office, etc. An inbound order also can be the receipt of goods that are, for example, further processed by the company before sale to the ultimate customer.

After the order has been received, the fulfillment coordination engine splits the order into one or more work packages based on a first set of rules or parameters (step 110). For example, if the order is for a good or product, the company can split the production procedure for producing the good or product into discreet work packages. The work packages can be based on, for example, rules such as location of the production of the product, location of the parts or goods used to make the product, and steps in the production process relating to different operations. Thus, a first work package may be for procuring raw materials, a second work package may be for shaping or forming the raw materials, a third work package may be for assembling the shaped materials into a final product, and the fourth work package may be for shipping the product. In general, the work packages are based on rules relating to the company's production process.

After the order has been split into work packages, the fulfillment coordination engine assigns the work packages to partners based on a second set of rules or parameters (step 115). These rules can be based on a company policy that sets a priority for partners, e.g., use partner A in preference to partner B and use partner B in preference to partner C. The rules also can be based on analyzing the costs and turn-around time for one partner in comparison to another partner, including an internal partner or an external partner. Like the first set of rules or parameters, the second set of rules or parameters are generally based on rules relating to the company's specific partners and production process. For example, the company can analyze past performance, costs, turn-around time, quality, etc. to set the rules.

After the work packages have been assigned to partners, the partners complete the tasks related to the work packages (step 120). These tasks can be completed in a parallel and/or a serial manner. The work packages can include any and all of the tasks related to the steps in a supply chain management, such as obtaining materials, fabricating products, and shipping parts to other partners. For example, one of the work tasks can include an external partner providing finished goods directly to the originator of the order (step 125). The company may request that the external partner provide the finished goods directly to the originator if there is a time urgency to receive the goods.

The work tasks also can include the internal and/or external partners supplying the goods to the company (step 130). For example, the company may compile the goods into a single shipment or may need to perform additional operations, such as the final assembly of the goods, prior to shipping. The company then provides the goods to the originator of the order (step 135). Providing the goods to the originator of the order may be based on a work package that includes the logistic service of transporting the goods from the company to the originator of the order. Following receipt of the goods by the originator of the order, the fulfillment coordination engine provides the company a confirmation of service (step 140). The fulfillment coordination engine next provides the company's billing and inventory management systems with data relating to the goods production, transfer, and sale (step 145).

The fulfillment coordination engine and method of fulfilling an order 100 can be implemented for numerous business, technical, and service scenarios that are necessary to depict cross-location logistics processes for supply chain execution. These scenarios and the required services are relevant to business processes and different system constellations. For example, one basic focus of the fulfillment coordination engine is the supply of a customer's demand in outbound order fulfillment.

The fulfillment coordination engine can be applied to additional scenarios that require an all-embracing coordination. These scenarios include processes with supply chain planning focus and, on the execution level, supply chain event management, inbound order fulfillment, and vendor managed inventory. Other executed level scenarios include processes that include production scenarios, ranging from lot production to make-to-order, engineer-to-order or assemble-to-order, that are followed by subcontracting in any possible way, processing cross-dock activities in a warehouse or storage location, control of a terminal hub without warehouse management, and value calculation of logistics services. All processes can be monitored by supply chain event management (SCEM), which also enables event-triggered actions within fulfillment coordination. Finally, fulfillment coordination enables the consolidated calculation of key performance indicators (KPIs) because the fulfillment coordination engine has access to the results of distributed working activities.

With respect to its functional areas, supply chain management can be divided into supply chain planning (SCP) and supply chain execution (SCE). Solutions for SCE include the functional areas of source, and make and deliver, both for cross-location and local processes. Local processes include manufacturing, warehouse management and yard management (aggregated to site management), transportation management, loading, and printing of necessary documents. Embracing processes require a cross-location coordination for all processes. This coordination can be handled internally, such as by a central logistics department, or externally, such as by 4th party logistics (4PL) service providers.

Some general processes in fulfillment coordination that are controlled by the fulfillment coordination engine include outbound fulfillment, inbound fulfillment, combined inbound/outbound fulfillment, and cross-docking. Although each of these scenarios is different, e.g., with respect to the recipient of goods, there are similarities with respect to the operation of the fulfillment coordination engine.

In outbound fulfillment scenarios, such as those scenarios in which the company is supplying a product to a company as a result of a sales order, the fulfillment coordination engine controls the actual fulfillment of a sales order. The fulfillment coordination engine also sets the touch point of customer order management in Customer Relationship Management (CRM) processes and order fulfillment within Supply Chain Management processes. As described above with respect to FIG. 1, the fulfillment coordination engine controls follow-up activities in the logistical execution that result from the customer order and determines the partners involved. The fulfillment coordination engine in step 115 assigns and forwards the work packages for warehousing and transportation or for further logistical services to the partners involved.

The delivery of a sales order (step 105) in an outbound fulfillment scenario can be executed by different, internal or external, partners in the fulfillment process. When stocks used in the fulfillment process are distributed over different physical locations, which can be handled by internal or external partners, the fulfillment coordination engine determines these partners and provides the information important to do the actual work on time. In particular, the fulfillment coordination engine splits the sales order into one or more work packages (step 110) and assigns the work packages to the partners (step 115). The work packages include the information necessary to perform the actual work on time. For example, the work package can include estimates of the time necessary to perform each work task such that the partners will know when to start the work so that the work is completed on time.

Possible partners in the outbound fulfillment process are different profit centers within the company. Examples of profit centers within the company include warehousing departments. Other possible partners include external business partners, such as logistics service providers, e.g., transporters of raw materials and goods. If the partners are external partners or internal partners, it is likely that the partners are at different locations. As such, to coordinate the fulfillment of the sales order, the fulfillment coordination engine enables the split of the sales order into work packages for the actual fulfillment at the site where the various materials are stored. For example, if the final product is an assembly of multiple parts that are produced in different processes, each process may be performed by a different partner at a different location, the final product may be assembled at another location, and the final product may be packaged and shipped to the customer at yet another location. The fulfillment coordination engine splits the order into work packages for each partner (step 110) and assigns the appropriate work packages to the partners (step 115).

As part of the process of splitting and assigning the work packages, the warehouses and the transportation management system may be informed about the materials and quantities that have to be picked up from suppliers, packed for shipping, and ultimately shipped. The shipments can be those made to the partners at an early stage in the production process and/or to the customer after the final product is assembled. Moreover, the shipments can be consolidated for execution to achieve an improved overall efficiency of the fulfillment process. Thus, shipments of different products from different production facilities that are sent to a single customer can be consolidated into a single shipment to, for example, reduce shipping costs.

After receipt of the products by the customer (step 135), the fulfillment coordination engine reports a confirmation of fulfilled services by the transportation management or site management (step 140). The fulfillment coordination engine then forwards the confirmation to other partners to initiate follow-up activities, such as billing or inventory management (step 145).

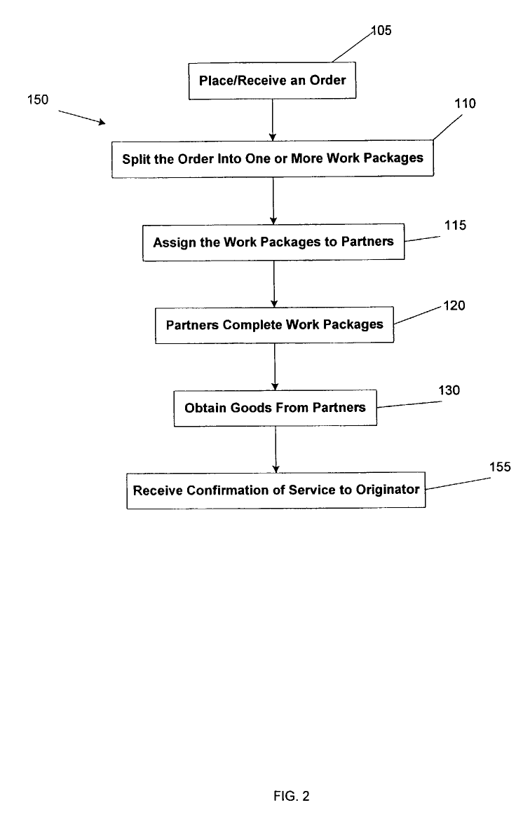

Referring to FIG. 2, for inbound fulfillment scenarios, such as the receipt of goods, the fulfillment coordination engine is applied to and controls the processes related to an inbound delivery of the goods. An inbound fulfillment scenario 150 can be viewed as a subset of a general outbound fulfillment scenario. Examples of inbound deliveries include those resulting from purchase orders to vendors for materials used in a production process, from stock transfer orders to a distribution center, and returns to a distribution center. Thus, in any of these inbound fulfillment scenarios, an order is created or received for procurement or receipt of goods (step 105). The fulfillment coordination engine splits the goods receipt process into work packages or tasks (step 110) and assigns each work package to those partners involved (step 115). The engine splits the goods receipt process into work packages based on a first set of rules that the company can create or specify. These rules may be based on, for example, the location of the goods receipt and tasks that must be accomplished to provide the goods. As a result, the original order can be split when different tasks and/or partners are necessary.

One inbound delivery scenario that can be processed with the fulfillment coordination engine is a consolidation of different orders or different order items such that the orders or order items are combined into one specific logistics task. For example, in the retail business customers may return goods to the retailer in which the goods were originally purchased. These returned goods typically are returned to the manufacturer or to the manufacturer's warehouse or distribution center. A transportation step is involved in this return. To ease the logistics burden on the manufacturer or the distribution center, deliveries of returned goods from several stores to one distribution center can be combined into a single shipment.

At all stages of the inbound process, the fulfillment coordination engine can handle inbound notifications from the partners involved. For example, a vendor may notify the company that the product has been completed and it is being shipped by sending a shipping notification. Similarly, a carrier may notify the company that it has transported the product to the distribution center by sending a transport notification. A vendor or carrier might also notify the company that its delivery is delayed due to weather or that the distribution center was not available to receive the product. After these inbound notifications, follow-up tasks can be performed with reference to one of the notifications or with reference to the original order.

After the work packages are completed (step 130), the final step of an inbound delivery usually is goods receipt (step 130). The fulfillment coordination engine can handle a two-step goods receipt with a rough goods receipt as the first step. After goods receipt, the fulfillment coordination engine triggers the company's warehouse management and inventory management applications and reports the result of the inbound fulfillment to the order system for invoice verification (step 155).

The fulfillment coordination engine can combine the inbound and outbound supply chain processes to manage those steps. FIG. 1 illustrates the general scenario in fulfillment coordination, but also can be applied to the scenario in which a company receives a customer order (step 105) and splits it into work packages (110) that are assigned to partners (step 115). Some of these partners are internal and some are external. Receipt of the goods from the external partners (step 130) is an inbound supply chain process. To enable this type of processing, when an external procurement (e.g., using an external partner) is necessary to fulfill a customer order, the fulfillment coordination engine connects the customer order to the purchase order made to the external partner. Upon finishing the inbound processing, the fulfillment coordination engine automatically triggers the outbound processing for the customer order (step 135).

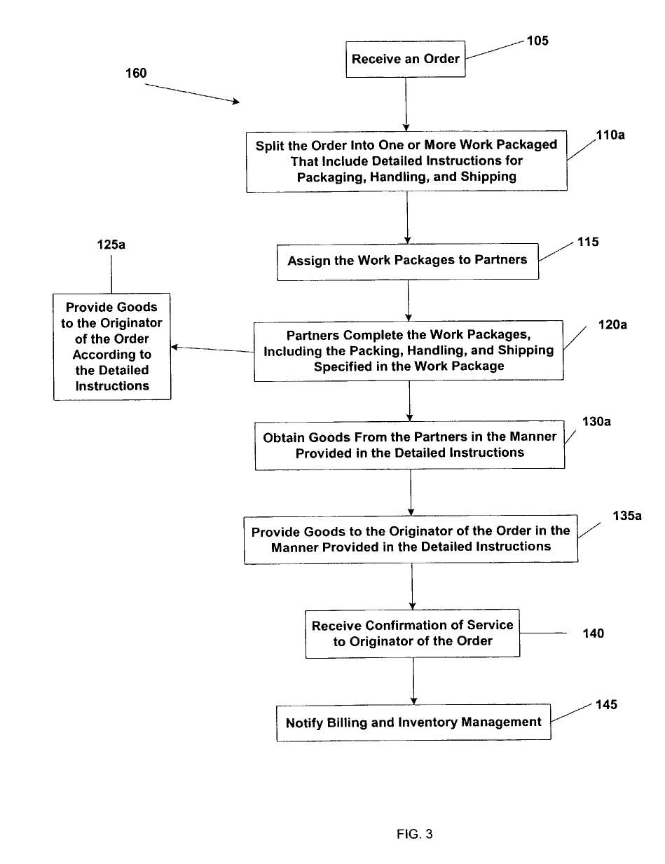

In the process of cross-docking, materials are processed directly from the goods receipt area to the point of use or goods issue area without first being put away in the warehouse. The fulfillment coordination engine enables a cross-location supply chain oriented processing of cross-docking 160 as illustrated in FIG. 3. Cross docking enables a quick distribution of materials without needing to process many steps or even perform a stock put-away or storage in the distribution centers. As such, the fulfillment coordination engine has to provide timely and detailed information to the distribution centers or other locations involved in the process. For example, the inbound shipments have to be identified and processes concerning the movement of the contained packages or handling units have to be prepared in order to avoid time consuming repacking. To accomplish this, the fulfillment coordination engine controls the communication between the central distribution centers and creates the order in which, and the manner how, the handling units have to be handled. Referring to FIG. 3, after receipt of an order (step 105), the work packages are created to include detailed instructions (step 110a). These detailed instructions can include, for example, the date on which the materials are to be shipped, the type of packaging, the type of handling units, and the order of packing the handling units. The detailed instructions reduce the logistics difficulties that can be encountered when cross-docking the materials. The work packages are assigned to partners (step 115), which complete the work packages including following the detailed instructions (step 120a). Based upon the detailed instructions, the resulting products can be provided directly to the originator of the order (step 125a) or back to the company (step 130a). If the goods are provided to the company, the company then provides the goods to the originator of the order in the manner provided in the detailed instructions (step 135a).

The actual execution of the movement of the goods may be fulfilled by site or warehouse management. However, the fulfillment coordination engine also is applicable to cross-docking that involves the handling of packages at transshipment points or terminal hubs without warehouse management functions. Finally, the confirmation of services executed is reported back to the fulfillment coordination engine (step 140) and forwarded to billing and inventory management (step 145).

The preceding description of the basic business requirements and the services that the fulfillment coordination engine must perform illustrate a subset of the various scenarios that the fulfillment coordination engine is capable of processing. The implementation of such a fulfillment coordination engine is generally based on a phased approach using increasingly complex configurations, which are described in greater detail below.

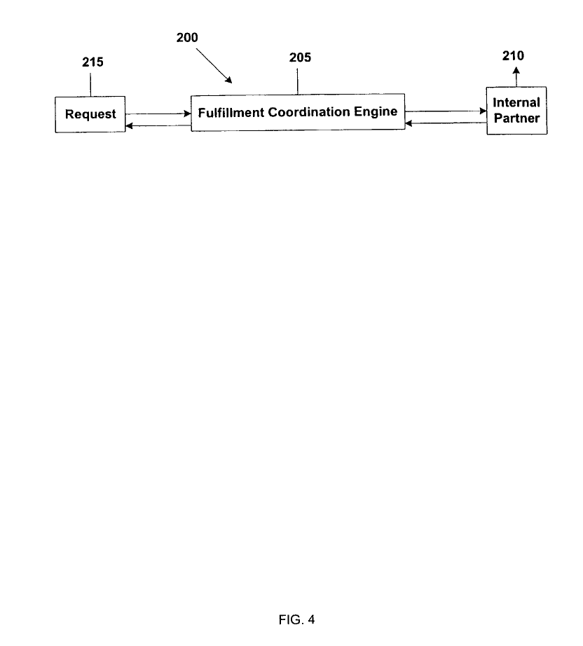

Referring to FIG. 4, a first, simple configuration 200 of the fulfillment coordination engine 205 is as a bare routing configuration useful for the scenario in which the partners 210 are already uniquely designed or specified at the time that a fulfillment coordination process is initiated (i.e., in the form of a request 215). In the simplest configuration, the fulfillment coordination engine merely functions as a data transmitter and triggers the execution of the fulfilment coordination process rather than actually controlling the process. Although this simple function can be provided by other available software, such as the basis component titled Exchange Infrastructure, available from SAP of Walldorf, Germany, this configuration of the fulfillment coordination engine is the basic scenario for all other more advanced business configurations. Thus, the fulfillment coordination engine also should be able to work as a simple router.

Even if functioning as a simple router, the fulfillment coordination engine of FIG. 4 uses the integration services of SAP's basis component, Exchange Infrastructure, and nonetheless provides new features for the execution of logistic processes. These new features result because of the tight integration of the fulfillment coordination engine with SAP's Supply Chain Event Management which provides the full visibility of all involved processes and additionally provides the triggers for all further activities. A further value added is the presence of SAP's Supply Chain Performance measurements, which are used to provide a detailed analysis of the executed processes.

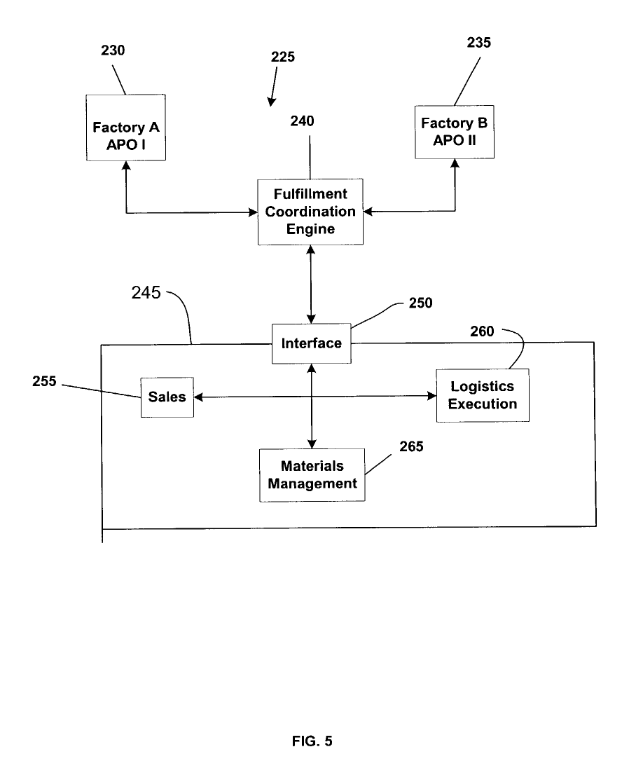

Referring to FIG. 5, even in this simple configuration, a company can obtain benefits. For example, in a basic scenario 225 a company creates an internal request to provide a product in response to a request from a customer. In this scenario 225, the company includes one SAP R/3 application and multiple SAP APOs, which are enterprise resource planning and advanced planning and optimizing software applications, respectively, available from SAP of Walldorf, Germany. The company includes a first factory or facility 230 running SAP's APO I and a second factory or facility 235 running SAP's APO II, both of which are available from SAP of Walldorf, Germany. The first factory 230 and the second factory 235 are located at the same general location such that the fulfillment coordination engine does not need to provide a routing service for the materials produced. The company also operates a fulfillment coordination engine 240 that interfaces to a R/3 application 245 through an interface 250. The R/3 application 245 includes a sales module 255, a logistics execution module 260, and a materials management module 265. Although the scenario appears different from the configuration 200, the scenario 225 is merely a situation in which the sales and the executing internal partner belong to the same system or company. The value added in the process results from the fulfillment coordination engine providing data matching and translation features. As indicated in FIG. 5, the factory 230 running APO I plans a stock transport for the factory 235 which is running APO II. Following the planning by the factory 230, the fulfillment coordination engine is triggered and creates a stock transport in the R/3 system 245, which processes information for both of the plants and the transport requirement in APO II.

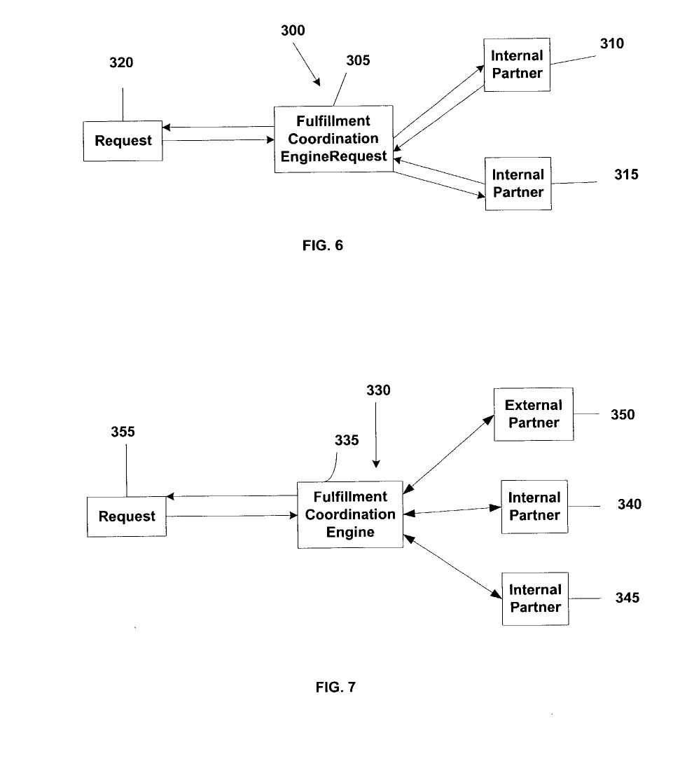

Referring to FIG. 6, the next level of complexity is a configuration 300 of a fulfillment coordination engine 305 that includes linking multiple execution partners 310, 315 to a sales organization that receives an order (i.e., a request 320), all of which belong to the same organization, but are regionally separated. In this scenario, the fulfillment coordination engine 305 provides a routing service, for example between the regionally separated execution partners, that can be parameterized by business entities. Examples of these parameters include materials, plants, or regions. The supported features include providing available-to-promise (ATP) information, and triggering and tracking processes. The largest part of the execution process is still be carried out by the individual partner.

Another application of the fulfillment coordination engine 305 is for use with the Distributed Order Management software of mySAP CRM, which is business software available from SAP of Walldorf, Germany for customer relations management. An objective of this application is to link a CRM system to multiple SAP R/3-backends which themselves are tied to one APO. Moreover, multiple SAP R/3 systems can be used with and without one or many APO systems.

Another suitable business environment in which the fulfillment coordination engine 305 can be applied is for a multinational company with sites in country A and country B. Each of the sites of the company corresponds to a R/3-system. In this scenario, the fulfillment coordination engine provides a priority for the sourcing of materials to fulfill an order. For example, the priority parameters can be set to require the fulfillment coordination engine 305 to look for fulfilling the request first in country A, then in country B. In general, however, in this configuration the fulfillment coordination engine is triggered by APO I and the ATP check. The engine then triggers further action and transfer requirements but does not control the execution of the operations necessary to fulfill the order.

Referring to FIG. 7, the next level of complexity is a configuration 330 of a fulfillment coordination engine 335 that includes linking multiple internal execution partners 340, 345 and external execution partners 350 to the fulfillment coordination engine 335 to process a request 355. This configuration 330 is essentially an extension of the intra-ecompany business of FIGS. 4-6 to include external partners for procurement as an alternative to inhouse-production and inhouse-sales. The external partners can be at remote locations or at a similar location as the company. A vendor (e.g., external partner 350) can be determined and informed by the fulfillment coordination engine 335 about the necessity to deliver goods to a customer. The vendor may be determined based on an individual search, such as the individual search provided by SAP's Global ATP module in APO. The vendor also may be determined based on existing or prior purchasing contracts. Although the configuration is more complex than the earlier configurations described above, the fulfillment coordination engine triggers the execution of the operations to fulfill the customer order but does not actually control the processes of fulfilling the order.

One particular scenario to which the configuration 330 of the fulfillment coordination engine is applicable includes a merger of companies. After a merger, both companies may still have individual execution environments, but a common sales force (i.e., “one face to the customer’). The merger between tire companies Goodyear and Dunlop is an example of a merger in which the fulfillment coordination engine 335 is applicable and beneficial.

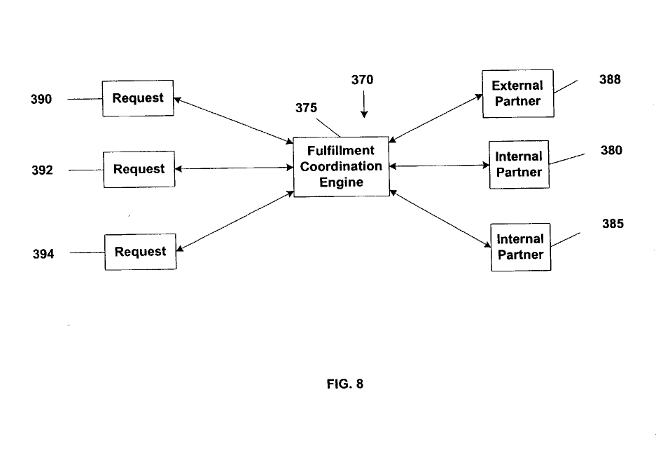

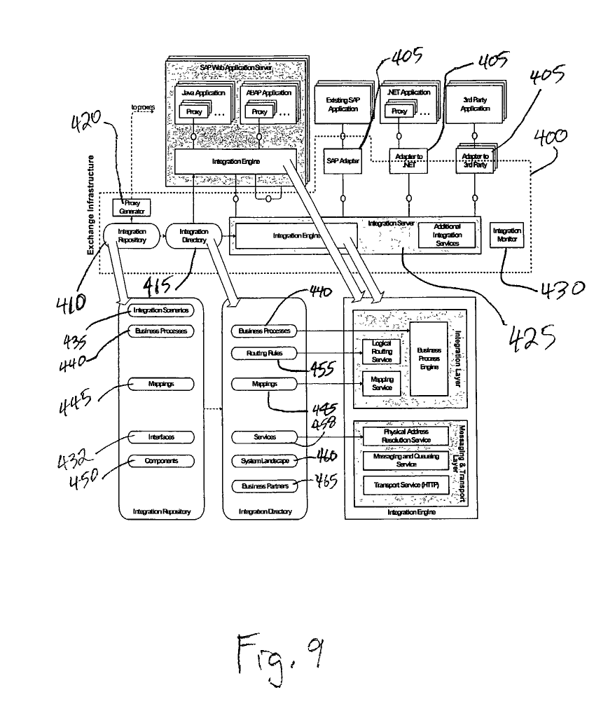

Referring to FIG. 8, the next level of complexity is a general configuration 370 of a fulfillment coordination engine 375 that includes linking multiple internal execution partners 380, 385 and external execution partners 388 to the fulfillment coordination engine 375 to process numerous input requests 390, 392, 394. This arbitrary number of input requests requires the company to perform logistics fulfillment that corresponds with a likewise arbitrary number of logistic partners, which may be internal or external to the company. The logistics partner may be systems, agents, human beings or any kind of device with which communication is possible.

The configurations described above can be applied to many modes of operation. Two such modes of operation are direct delivery or shipment and stock transfer or consolidation. In the direct delivery or shipment mode, a direct delivery is made from the supplying plant/distribution center/vendor to the goods receiver of an ordering customer (i.e., order originator). This mode of operation is important when the time to perform the real shipping is very short. For example, the spare part business is a good example where this mode of operation is necessary to maintain a high level of service.

In the stock transfer or consolidation mode, the objective of the operation is to create one delivery per customer. This mode also takes into account a merge in transit at a consolidation point. For example, goods from multiple internal and external partners can be shipped to a consolidation point and then shipped as a single shipment to the customer. The operator of the consolidation point also can be instructed in the manner of packing and preparing the handling units for the cross-docking situation.

The configurations described above are generally those in which the fulfillment coordination engine is used to trigger the execution of the fulfillment process but does not actually control the process. For example, the fulfillment coordination engine may be an add-on component for an already existing logistics engine of a company rather than a complete replacement or entirely new system. Thus, the fulfillment coordination engine is capable of use in a step-by-step enhancement, take-over, or ramp-up of the functions of the existing employee resource planning system. In so doing, the engine ties together many different sales organizations and execution partners, whether they be internal or external to the actual company. Similarly, the media with which the communications to and from the fulfillment coordination engine are carried out is irrelevant because every communication uses a common system, such as SAP's Exchange Infrastructure (El).

One of the most challenging enhancements for using the fulfillment coordination engine in a transition from an add-on service to a self-sufficient logistics engine is that resulting from the fulfillment coordination engine no longer being used solely to trigger the execution, but rather controlling the execution and the subsequent process. Moreover, the fulfillment coordination engine can be enhanced further to replace the external services of the existing system. Examples of the existing systems that can be replaced by the fulfillment coordination engine are described below. In general, the services used to replace an existing system manage a single logistics task. The ability to replace existing external services with new services of the fulfillment coordination engine is an important step in the transition from using the fulfillment coordination engine as an add-on service for already existing logistics components into a self-sufficient logistics engine that any fourth party logistics provider can use to drive its businesses.

On a high level of a logistics scenario, the fulfillment coordination engine basically operates as follows. The original logistic request (e.g., customer order, return goods notification) will be split or distributed into different logistic activities. All of the logistics activities belonging to one specific request form a logistics object. Comparable activities from different logistics objects can be consolidated into one or more common logistics orders. Common logistics orders include deliveries to a common receiver, arbitrary transport, and monitoring of valued-added services, such as packing or labelling and monitoring of assembly activities.

If the fulfillment coordination engine is being implemented with an existing SAP application, some of the operational services will remain unchanged. One such service that will remain unchanged is that of determining the delivery location with APO's Global ATP, which also is used for the determination of the date and quantity when the request is going to be delivered. Other unchanged services include the planning of transports within APO's Transport Planning component and the calling of APO's Foreign Trade component.

The necessary operations to fulfill the request or order are communicated to corresponding partners using standard interfaces and formats. Together with the operational services there are a variety of features to track, monitor and evaluate the business flow to extract performance indicators, which can be used as feedback to the execution to adjust the control parameters that are executing the request. As such, using the fulfillment coordination engine in this manner provides adaptive fulfillment coordination.

A first service that can be connected to the fulfillment coordination engine is a Basic Services module or application which connects the fulfillment coordination engine and supply chain management to the SAP Basis Services. These services encapsulate common and auxiliary technical functions and are necessary to connect fulfillment coordination to the SAP Basic Services and/or the SAP Integration Server. The tasks of these services include printing, user interface handling, data mapping, authorization, archiving and master data access.

A second service that can be connected is the Supply Chain Management (SCM) Services application that provides common application services that can be used by different SCM modules. These services are common, auxiliary application functions. In general, there are three different classes of common application services: information services, document services, and process services.

The information services class provides decision support and includes, for example, using ATP without the use of any documents. The decision support is useful for the further evolution of the actual logistic process. The document services class provides a conversion method for documents. The method includes receiving the necessary information from the document as input, determining the target, and providing an output back to the calling task as a different document. An example of the conversion method includes creating a delivery note from a sales order by using the necessary information on the sales order, determining which party should receive the task of fulfilling the sales order, and providing a delivery note to that party. The process services class involves the handling of many or all of the documents used in the order fulfillment process. For example, the process services class includes archiving of documents as one service.

A third service that can be connected to the fulfillment coordination engine is the Fulfillment Coordination Services application, which is used for the construction and implementation of fulfillment processes.

There are additional services available from SAP that also can be used with the fulfillment coordination engine to provide additional functions and benefits. Although these services enhance the capabilities of the fulfillment coordination engine, they are not necessary to use the fulfillment coordination engine.

The Process/Task Determination service is used to determine the logistics process and the logistics steps that are necessary to fulfill an order/order item. The logistics processes are initially defined by using a Collaboration Designer function. The assignment of the logistics processes and steps to the actual request is achieved by evaluating the parameters of the individual business process. Thus, if an order needs to be processed according to a sequence of operations, that sequence will be defined using the Collaboration Designer function. Running the Process/Task Determination service will determine for an order which operations need to be used to process the order. This service is used, for example, when breaking an order into work packages.

The ATP service is used to check the availability of an order quantity of a product for supplying the product by a certain date. To meet the date and quantity requirements, the ATP service is able to adjust various parameters of a logistics process, including changing the steps of a logistics process, changing the partners/locations, changing the schedules, and changing the products. The ATP service is connected to one or more of the programs, described below, that provide: (1) scheduling of the processes (e.g., to determine the actual date of fulfillment), and (2) product selection or substitution, partner/location selection, capable to promise (CTP) service, production planning and scheduling, planning in general (e.g., forecasts, product allocations) and alert handling (e.g., if there is no confirmation for a request).

The scheduling program is a service that determines the schedules for every step of a logistics process, such as transport schedules, shipment schedules, processing schedules in a warehouse, schedules for value add services, etc. The scheduling service is connected to the ATP service to provide for a transfer of data.

The product selection or substitution service selects the correct product for a logistics process according to batches, serial numbers, shelf life expiration date, and stock determination (i.e., type of stock: on hand, blocked, inspection, etc.). The product selection or substitution program also may substitute products based on predefined parameter (e.g., a listing of acceptable product substitutes) and connect the bill of materials to handling the bill of materials. For example, a customer may need a product that is unavailable in the time frame specified in the order. The program then can determine an acceptable substitute product based on parameters that the customer has provided for the product. One such example is paper for copying. The customer order may specifiy a particular brand of paper. If that brand is unavailable, the program may substitute a different brand of paper that otherwise meets the customer's criteria based on parameters provided to the program. Like the scheduling service, the product selection or substitution service is connected to the ATP service for the transfer of data.

The partner selection service selects the partners involved in the steps of a logistics process using rules determined by the company. Examples of partners that can be selected include customer, supplier, production plant, distribution center, carrier, locations, and service provider. The partners for a logistics step are defined by the Collaboration Designer using rules provided by the company. Some of these partners may correspond directly to systems or addresses of, for example, marketplaces. The partner selection service is connected to the ATP service for the transfer of data.

The warehouse management service controls warehouse zones (e.g., goods receipt zone, goods issue zone, etc.), storage locations, the contents of the zones and locations, the warehouse internal transports (e.g. bin replenishment), and other zones and attributes relevant to a warehouse. To enable information to be entered into the fulfillment coordination engine from the warehouse, the warehouse management service provides inbound and outbound interfaces to mobile devices and external control systems. In this manner, data associated with the receipt of goods in, or shipping of goods from, a warehouse can be input into the fulfillment coordination engine. This data may be further processed to send a shipping notification to the company.

There also are services that can be used with the fulfillment coordination engine that are used to construct and implement the order fulfillment process. A first such service is order selection and maintenance. The service provides inbound and outbound interfaces to different order systems, such as APO, CRM, R/3 and external systems. The service exchanges status information with these systems and handles subsequent changes in the orders. The service adds logistics master data to the incoming orders if that type of data is not already present in the order and provides protocol data for the monitoring of the complete process.

A second service is the delivery module. The delivery module controls the inbound and outbound deliveries within the fulfillment coordination engine, such as by creating the outbound delivery note. The module also connects inbound delivery notes to the correct logistics process.

A third service is the transport module. The transport module provides planning and execution functions, such as transport planning, vehicle scheduling, yard management, and transport documents. For example, the transport module provides transport documents, such as freight documents, load documents, and route documents. The transport module also interfaces with other modules, including logistics costs, dangerous goods and foreign trade modules, which are described in more detail below. The transport module also interfaces with applications or modules, such as an inventory management engine (LIME), ATP, and the partner selection module, described above.

A fourth service is the goods receipt service, which supports inbound goods movements. The goods receipt service checks the incoming delivery and posts the movement to stock. The goods receipt service is connected to applications, such as warehouse management and LIME. To provide an easy method of on-site entering of data relating to inbound goods movement, the goods receipt service provides inbound and outbound interfaces to mobile devices.

A fifth service is the goods issue service, which supports the outbound goods movements, such as checking the outgoing delivery, and posting the movement to stock. The goods issue service is connected to applications, such as warehouse management and LIME. Like the goods receipt service, the goods issue service has inbound and outbound interfaces to mobile devices to provide an easy method of on-site entering of data relating to outbound goods movement.

A sixth service is the notifications service, which can be created at different steps of a logistics process. Example of notifications that can be created by the notifications service include advanced shipping notification, shipping notification, and transport notification. The module manages and maintains all types of notifications. For example, the module connects inbound notifications to the logistics documents and creates outbound notifications and internal notes for monitoring purposes.

A seventh service is the picking module, which controls the picking process in a warehouse (e.g., retrieving product from inventory in a warehouse). For example, the picking module creates picking documents and performs picking confirmations. The picking module also supports different picking types (e.g., 1 step, 2 step, etc.) and can form picking waves. The picking module provides inbound and outbound interfaces to mobile devices and may have interfaces to a warehouse management system.

An eighth service is the packing module, which controls the information relating to different types of packaging materials. For example, packaging materials that are controlled can be simple packaging material (e.g., boxes), loading equipment (e.g., pallets), and transport equipment (e.g., containers). The packing module uses packing rules to connect the process of packing the product to materials and/or logistics processes. The packing module can handle simple packaging (e.g., package in a box) and more complex multi-level packaging (e.g., package individual products in a box and store twenty boxes on a single pallet). The packing module also has additional functions. One additional function is to create packing documents, which are transferred with the product to the next location or the customer. A second additional function is to perform confirmation of the packaging of a product or of the loading of a product onto loading equipment. This confirmation is useful when notifying a logistics partner, such as a shipping service, that the product is ready for pickup and shipping. A third additional function is to calculate and collect the costs for packing. For example, the customer may request a particular, expensive form of packaging that is not included with the cost of the product. Using this function of the packing module, the company can calculate and bill this additional cost. Alternatively, the company can use this function to track the costs of packaging its products.

A ninth category of services is that of value-added services. These service encompass separate tasks that can be executed during a logistics process and provide extra value for the customer. Examples of these value-added services include, for example, packing, labeling, mounting, and installing. Each of these tasks is implemented as a separate service and the value-added services module provides the following functions for each instance of the use of the separate service: (1) create the necessary documents for executing the value-added service, (2) perform confirmation of execution of the value-added service, and (3) calculate and collect the costs for value-added service.

The final services that can be implemented with the fulfillment coordination engine include a group of services that are not used for the construction of the fulfillment processes but instead are used to collect data from the fulfillment process. One of these services is the logistics costs service, which collects all cost-relevant information from a logistics process. With this service, the fulfillment coordination engine assigns the logistics costs to the different partners of the logistics process. Logistics costs that can be collected and assigned with this service include freight, value-added costs, insurance, customs duties, warehousing costs, handling costs and packing costs. The logistics costs service also includes interfaces to an accounting module to use the cost data in that module.

A second service is the dangerous goods module, which is used to manage the handling of dangerous goods. The management of dangerous goods includes checking for legal requirements (e.g., shipment terms, means of transport, packing regulations, etc.), creating the necessary documents, and calculating and collecting the special costs for dangerous goods handling. The dangerous goods module includes interfaces from and to the foreign trade modules, packing module, transport module, and logistics costs. The foreign trade modules are necessary because of the various different legal requirements.

A third service, the foreign trade module, controls and maintains all information concerning foreign trade. An example of one type of foreign trade information includes checks for legal requirements, such as applicability of export licenses and possible inclusion on boycott lists. Another type of information is the calculation and collection of foreign trade costs, such as customs duties and insurance. A third type of information relates to the creation of the necessary delivery documents, such as export license papers, customs documents, and certificates of origin. A fourth type of information relates to the creation of periodical information that must be supplied to customs and foreign trade authorities.

A fourth service is the key performance indicator, which collects all information necessary to measure the performance of the logistics processes controlled by the fulfillment coordination engine, including time indicators and quality indicators. The key performance indicator service is connected to SAP products, such as SAP BW and SC Performance Management.

The fulfillment coordination engine, with or without the services described above, can be implemented on a development platform, such as a SAP system using SAP Technology release 6.20 and Application Basis Component release 6.20. The programming language used with the system can be, for example, ABAP, which can be used for all operative programs. Two reasons to use a programming language, such as ABAP, are that there is a need to read data from a database and the known advantages that ABAP provides for advanced business programming.

The fulfillment coordination engine also can be provided with a strict separation between the user interfaces and the programs associated with the engine. In general, all user interactions with the engine are possible using the Internet with Java.

The fulfillment coordination engine may be tightly integrated to an integration server. If the engine is implemented as a SAP product, all necessary technological features are provided by the Exchange Infrastructure of SAP Technology and the necessary business content for the exchanges is delivered by the fulfillment coordination engine. In particular, the fulfillment coordination engine may be a package of SAP's R/3 Enterprise, SAP's CRM, and/or SAP's APO. Such a package consists of a hierarchical set of packages according to the layer model of the fulfillment coordination engine described above.

In its implementation, the fulfillment coordination engine usually avoids having master data, which thereby causes the engine to use locally existing master data whenever this is possible. Thus, rather than having master data, the fulfillment coordination engine only keeps the logistic data that are necessary to pursue its essential tasks, namely the execution and the monitoring of logistic processes. The rationale for this approach is that a stand-alone engine might impose the creation of persistent views to centrally existing master data because of performance reasons.

Finally, although the fulfillment coordination engine uses supply chain execution management (SCEM) for all tracking purposes, the use of SCEM is not mandatory for its operation. Because the engine can be implemented in a layered manner, as described above, SCEM does not need to be used if other modules or services are instead used. Therefore, some features present in SCEM, such as providing status or reference information, are implemented in the fulfillment coordination engine as well.

As described above, the fulfillment coordination engine can be implemented with SAP's Exchange Infrastructure. Implementing the engine with SAP's Exchange Infrastructure provides an infrastructure that has a middleware which allows technical integration of SAP as well as non SAP systems by using open standards, such as XML and Java. This implementation also provides an open framework that allows the separation of integration customizing and coding (i.e., routing, mapping, etc.) from application coding. As described in more detail below, using the fulfillment coordination engine in an integrated system with the Exchange Infrastructure, integrates systems from the point of view of business logic and allows cross-system order fulfillment processes. Following is a brief description of the main parts of the exchange infrastructure is given.

Referring to FIG. 9, the architecture of the exchange infrastructure 400 includes adapters 405, an integration repository 410, an integration directory 415, proxies 420, an integration server 425, and an integration monitor 430. The communication between the exchange infrastructure and other systems is based on an enhanced SOAP script language. However, if systems cannot support this protocol, the adapters 405 are used to map the external protocol to SOAP. For SAP's R/3 systems, adapters 405 are necessary for synchronous RFC and IDOC.

The integration repository 410 contains outbound and inbound interfaces 432. The repository 410 can contain interfaces for all SAP components and interfaces for non-SAP systems. The repository 410 uses a standard XML language to describe services, such as WSDL. Interfaces for already existing functions (e.g., BAPIs) can be generated by extractors. Prior to using the exchange infrastructure, all outbound and inbound interfaces that may be used must be contained in the integration repository. If an interface is not added initially, it must later be added to be used. The integration repository 410 also contains information about integration scenarios 435, business processes 440, mappings 445, and a component repository 450. The mappings 445 convert a message or parts of a message into another message or parts of another message. Mapping is used with XML documents and can be performed using XSLT sheets or Java coding. If used with SAP Basis, structure mapping may be performed with XSLT sheets and value mapping may be performed with Java. Mapping may be performed using several mappings steps (i.e., several Java function) that are executed in a sequence. Each step also can be a sequence.

The mappings 445 may include a repository that contains the mapping rules for an outbound-inbound interface combination. There also may be several mapping rules for one combination. The mappings 445 also may include a directory that contains for each combination of outbound, inbound interface and direction exactly one mapping rule that is used during runtime.

The component repository 450 contains descriptions of all components (i.e., their version, relations and dependencies).

The integration directory 415 includes the information about the interfaces a specific customer uses. This information is maintained by the customers or their consultants when they configure the systems for their particular scenario. The directory 415 also includes information about the business processes 440, the mappings 445, the routing rules 455, services 458, the system landscape 460, and the business partners 465. The mappings 445 in the integration directory 415 may be similar to or the same as the mappings 445 in the integration repository 410.

The routing rules 455 are used to determine the routing of the engine. During runtime, the routing functionality determines which receiver system and which inbound interface has to be called according to the outbound interface of the sender and the content of the message. The routing rules 455 are defined when a specific customer configures his scenarios and refer to routing objects, XPath expressions or Java coding. The routing rules 455, XPath expressions and Java coding are maintained in the routing rules within the directory 415. Routing objects are created during design of the interfaces in the repository and contain the information fields, which determine where the message has to be sent.

The services 458 contain information about the services described above. For a specific customer configuration, the system landscape directory 460 contains information about the installed components (e.g., the addresses of the systems). The business partners 465 include information about the company's business partners. This information may be used, for example, in selecting business partners to execute work packages.

The proxies 420 function as the interfaces of the exchange infrastructure to the applications. They are generated according to the interfaces maintained in the integration repository 410, and can be generated in Java and ABAP. For an outbound interface the application calls the corresponding proxy. Calling the corresponding proxy triggers the generation of the XML document, which is sent to the receiver. For an inbound interface the proxy framework receives the XML document, converts it to ABAP or Java, and calls the application via the corresponding proxy.

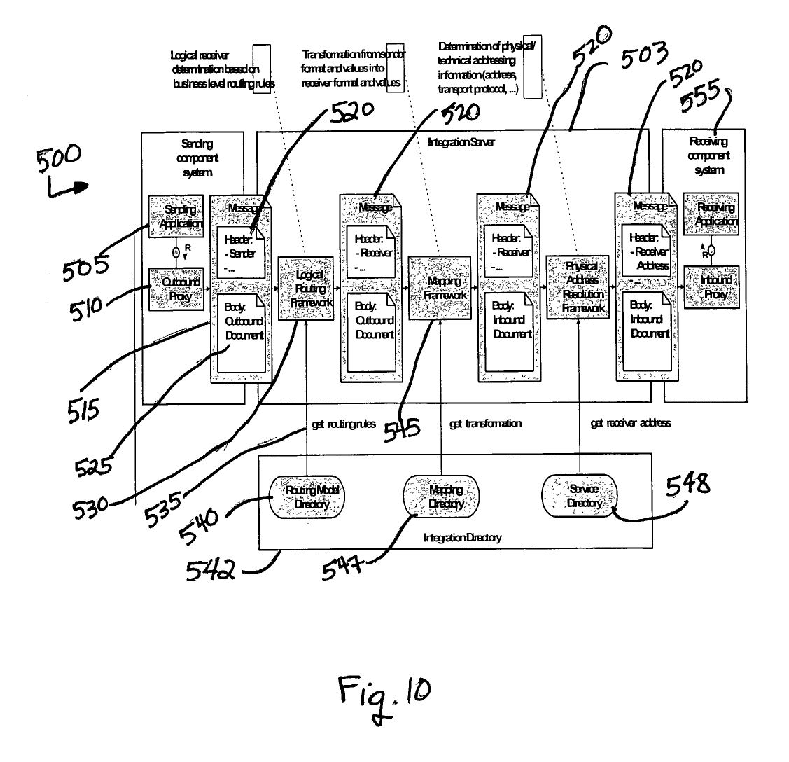

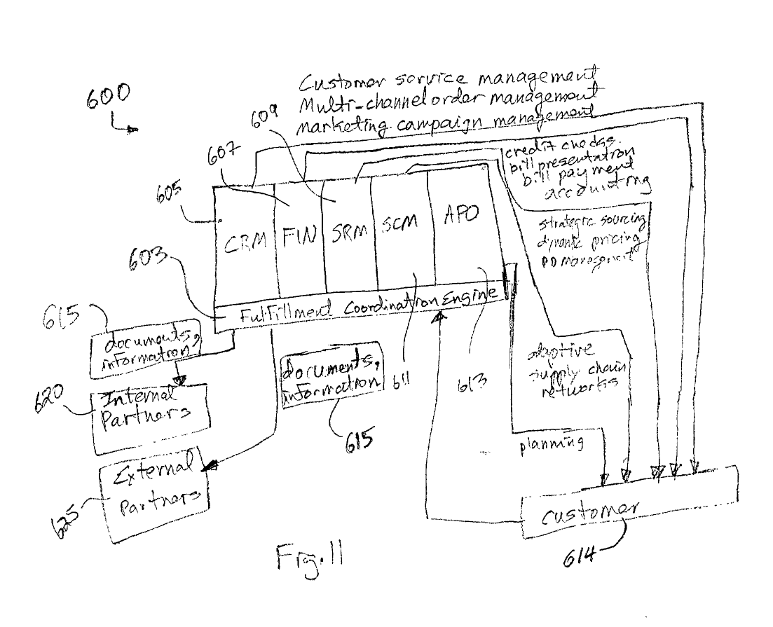

Referring to FIG. 10, a detailed illustration is provided of the message flow 500 in the integration server 503 between a sender and a receiver of a message. Initially, the sender uses a sending application 505 to call an outbound proxy 510. This causes the generation of a message 515 as a XML document. The message 515 includes a header 520 that contains information about the sender and the outbound interface and a body 525 that contains the outbound document. Using a routing framework 530, the integration server 503 then determines the receiver(s) and the inbound interface(s) according to the routing rules 535 of a routing model directory 540 contained within an integration directory 542. After this determination, the header 520 of the message 515 is modified to contain the receiver and the inbound interface. Then, using a mapping framework 545 that communicates with a mapping directory 547, the message 515 is transformed from the sender's formats and values into the receiver's format and values. After this transformation, the body 525 of the message contains the document converted to the inbound format (i.e., the structure that the receiver understands). Finally, the physical address of the receiver is determined using the data of the system landscape directory 550 and by communicating with a service directory 548. That information is added to the header 520 of the message 515 and the message is sent to the receiving component system 555.

The fulfillment coordination engines described above can be applied to many industries. Specific examples are provided below to illustrate the functions and benefits of specific applications of the engine. For example, the fulfillment coordination engine can be used as a forwarding agent in a logistics service scenario. One such logistics service scenario includes inbound and outbound collective goods traffic, which is applicable to most industry sectors, but to logistics services in particular. The engine is used when delivering goods from multiple shipping customers to a group of commercial ship-to parties. The shipping customers may be small or medium-sized companies. The engine executes the process on the sender's initiative. There can be a variant in the engine related to billing by sending only one invoice for a transported shipment to the sender and one to the ship-to party. The engine can optimize the processes. For example, on local journeys, the engine can be used to provide a daily allocation of shipments to vehicles and routes and include a planned organization of the sequence of stops along the route. The engine also can be used to provide a monthly review of the route areas, route boundaries, and the vehicle mix within the local zone. On long-distance journeys, the engine can be used to plan routing by performing a daily optimization of the outbound long distance journey. The engine also can be used to plan transportation options after completing a shipment pick-up. For example, the options that may be analyzed include: direct to ship-to party, cross-docking close to sender, and cross-docking close to ship-to party. The engine also can analyze the options based on whether to consolidate at the sender, the recipient, or by regions. The engine also can analyze and optimize based on carrier selection. For example, the provision of transport services can be standardized such that the logistics service can look for carriers daily in the marketplace, although in general the basic load is bought using longer-standing committed/guaranteed contracts with carriers and extra loads are bought by looking in the marketplace. Benefits of using the fulfillment coordination engine in this application include outsourcing, concentration of core competencies for the sender/recipient, and transport consolidation.

As another example, the fulfillment coordination engine can be used as a forwarding agent in a logistics service scenario that is based on a delivery contract. Although such a scenario is applicable to most industry sectors, it is particularly applicable to consumer products in which demand may be high and there is an urgent need to fulfill the delivery contract. In this scenario, the engine can be used to in the transport of products from warehouses or plants of a manufacturer to regional warehouses or retail stores. The goods delivery is typically from one or a few large shipping customers to one comprehensive group of commercial ship-to parties. The shipment is usually made on the sender's initiative, which is also the one paying for the shipment. There is usually a long-standing relationship between the logistics service and the sender, including a contractual relationship. Because of the long-standing relationship, the logistics service tends to invest in the business relationship. The process is optimized in the same manner as in the inbound/outbound collective goods traffic scenario described above. However, in particular, using the fulfillment coordination engine results in a decrease in freight costs per metric ton, a load reduction at the loading ramp through the use of a consolidated pick-up, and a reduction of administrative work because there is only one invoice from the logistics service.

In another scenario, the fulfillment coordination engine can be used as a forwarding agent in a logistics service scenario that is based on a contract collection, which is applicable to all industry sectors but is particularly applicable to the consumer product and automotive sectors. The engine is used to control the logistics process from warehouses or plants of a manufacturer to regional warehouses or retail stores. In this scenario, the goods delivery is from one or a few large shipping customers to a manageable group of commercial ship-to parties. The system is optimized and the benefits are similar to the inbound/outbound and delivery contract scenarios described above. An additional benefit, however, is provided at the ship-to party's warehouse ramp because the shipping will be based on a consolidated delivery.

In another scenario, the fulfillment coordination engine can be used as a forwarding agent in a logistics service scenario that is based on an export by sea of products. Although this scenario is applicable to all industry sectors, it is particularly applicable to logistics service providers in which there is a goods delivery by sea from multiple shipping customers to a group of commercial ship-to parties. The engine is used to control both procurement logistics and distribution logistics. Although the system would be similar to the inbound/outbound collective goods system described above, additional functionalities are provided for the engine that are unique to sea shipping. For example, a functionality may be provided to control or provide instructions for: (1) the packing of goods into a sea container to ensure a full container load by the sender, (2) the staging at the sender's site by the forwarding company, (3) the loading of the goods into a collective loading container if there is less than a container load, (4) booking of freight space on a ship, and (5) letter of credit processing. The engine optimizes factors that are relevant in sea traffic, such as leg planning, load building, container circulation, modal swap, container break, and container break customs clearance.

In another scenario, the fulfillment coordination engine can be used as a forwarding agent in a logistics service scenario that is based on the auto industry. The engine is used to control both the procurement logistics and the distribution logistics of a simple procurement, such as obtaining parts from a single parts vendor, and a complex distribution, such as the final vehicle assembly. For example, the engine is useful when the logistics service runs a warehouse, such as a bonded warehouse, for a manufacturer and single parts vendors deliver directly to this warehouse. In this example, the manufacturer only releases products and the logistics service assembles all the necessary parts, packs everything (e.g., in containers), carries out customs processing, and dispatches the packed parts to the manufacturer. In this scenario, the engine operates on the basis of the logistics service provider having access to the bills of materials of the manufacturer's products and performing inventory management. The engine may provide instructions relating to packing in a given sequence per unit and ensuring that there is a batch purity for single parts per unit. The engine also may have functionalities to provide costs settlements with shippers, service providers, and freight forwarders. Using the engine in this scenario may optimize the customs processing steps and when preparing materials for production operations. By optimizing these steps, the company may save on duty costs and transportation services costs.

As well as being used as a forwarding agent in a logistics service scenario, the fulfillment coordination engine can be configured and used in specific industry scenarios. One such scenario is a vendor managed inventory in which a vendor manages the customer's warehouse and is responsible for the availability of the relevant article. The vendor must estimate the quantity of the stock commissioned. This is particularly applicable to consumer products. The engine is used to control the logistics between a supplier and a manufacturer or between a manufacturer and a retailer. A benefit to the parties includes improved transparency due to collaboration. This transparency provides more flexibility in fulfilling the customer's product needs, fewer bottlenecks, faster reaction times, and a possible reduction of safety stock in the inventory or warehouse.

The fulfillment coordination engine can be applied to just-in-time delivery scenarios, for example, in the automotive industry to control the supply logistics between a supplier and a manufacturer. The engine is most useful for direct delivery to the assembly line in which the manufacturer forwards to the supplier only the minimum stock requirements necessary for manufacture/montage. The certainty of supply is ensured by warehousing close to the recipient (i.e., the manufacturer) or having the capability of short-term secondary production at the supplier. Inbound deliveries of material are generally labor-intensive with respect to the material requirements planning and there are typically higher than average transportation costs. As such, the just-in-time delivery is most useful for scenarios that are based on supplying program-driven material. Nonetheless, even with these constraints, the fulfillment coordination engine provides transparency, which beneficially provides a continuous supply to match demand, a reduction of safety stock, faster reaction times, and fewer bottlenecks.

The fulfillment coordination engine also can be applied to the chemical industry for use as a procurement tool in the replenishment by the supplier of starting substances for production. For example, the engine can be used to control production supply when the chemical company is controlling the supply of materials by using a vendor-managed inventory and/or a vendor-driven consignment management. The vendor uses current stock and planned issues to control his own production. The vendor also can control consignment fill-up of a manufacturer's warehouses using a logistics service/freight forwarder. The engine may be configured to include a monthly collective invoice that does not have to be sent because it is already available to the chemical company. The supplier and the chemical company may optimize the system by conducting joint planning between the company, supplier, and logistic service providers that are involved. Even more optimization is provided if the company provides monthly forecasts a number of months into the future. The supplier and the company can benefit from the improved transparency that results in this scenario. The improved transparency can advantageously provide more flexibility, reduced administrative work because the chemicals are provided automatically, greater speed in responding to needs, lower costs and less working capital for the chemical company because it does not need to carry safety stock, separate orders are not necessary because orders for consignment fill-up are automatic, quality inspections may not be necessary, separate invoices are not necessary, and the chemical company only needs to pay for what it uses rather than for materials it purchases but does not use. Finally, there may be improved relationships between the partners/involved parties as a result of the collaboration between the vendor, logistics service, and chemical company.

The fulfillment coordination engine also can be applied to the retail industry in a pull/push warehouse scenario to control the flow of material from the vendor's warehouse to the retailer's store through the retailer's warehouse. The goods that are controlled in this scenario include those goods in the warehouse that are suitable for turnover that are delivered on pallets as well as average-moving and slow-moving goods that are not delivered to stores on pallets. The engine can control a warehouse that functions on a pull basis in which warehouse stock and forecast values act as a trigger to provide a reorder point. The engine also can control a warehouse that functions on a push basis in which there are planned values of goods for seasons that function as a trigger for ordering additional product. In these scenarios, the engine also controls the transport logistics. For example, the transport can be accomplished with a regional freight forwarder for customer destination regions or vendor source regions. Alternatively, a carrier can be commissioned by the vendor or one of the vendor's own fleet can be used to make the deliveries. Using the engine in these scenarios optimizes the quantity of warehouse stock according to the range of coverage of the warehouse. The quantity of stock in the warehouse may be set according to the range of coverage of the store, assortment of stock, the store's programs to optimize layout and stocks in stores, and the reorder point. The shipments can be optimized based on routes and using only full truckloads. The quantities also can be optimized by taking advantage of full truckloads, full pallets, and scale prices.

Like the push/pull warehouse scenario, the fulfillment coordination engine can be used in the push/pull leg of a direct store delivery scenario in which the goods are transported from the vendor's warehouse to the retailer's store. This method of delivery and logistics control is useful when handling bulky goods that cannot be handled easily in the warehouse, for fast-moving items that are transported on pallets to the store, for rack jobber goods in which the carrier fills the rack in the store, for companies without their own warehouses, and for those situations in which the individual store is physically close to the vendor. In a pull situation, by using the level of stock in the store, forecast values function as triggers when a reorder point is reached. In a push situation, the planned values for season function as triggers such that quantities are ordered on a planned date. A regional freight forwarder can be used for customer destination regions and a carrier can be commissioned by the vendor, or one of the vendor's own fleet can be used, to make the final delivery. To optimize the logistics, the amount and type of stock in the store is based on a range of coverage, an assortment, and the store's own programs to optimize layout and stocks in stores. The shipment logistics can be optimized based on the routes and taking advantage of full truckloads, using pallets, and obtaining scale prices.

Another scenario in which the fulfillment coordination engine can be used is for the delivery of goods to consumers from retailers, such as mail order vendors in which the goods are shipped from the vendor's warehouse directly to the customer. This can include direct shipping from the manufacturer to the customer by a freight forwarder/carrier, or the shipping of specially-made items for end customers (e.g., furniture), single-unit shipping, bulky goods (e.g., refrigerators). In this scenario, the customer orders the goods in a store, at a retailer, or over the Internet, and requests a specific delivery option, such as delivery within 24 hours. A service center can be used as the central interface between the involved parties (i.e., customer, vendor, logistics service provider). The logistics service provider manages the entire delivery from vendor to customer and is responsible for ensuring that the goods are delivered on time. An express delivery service can be used to make the home delivery to the customer. The shipment logistics can be optimized based on the routes and taking advantage of regional consolidation. The benefits of using the fulfillment coordination engine in this scenario include efficient management despite single units/bulky goods, no detour of the product through the retailer, and faster delivery to the customers.

The fulfillment coordination engine also can be implemented in numerous warehousing scenarios. For example, the engine can be used for warehouse management of a retail warehouse service in which the warehouse service manages a warehouse for a customer and all the activities for this customer (e.g., put-away, stock transfer, picking, removal from storage). For example, the warehouse management receives orders from customers for put-away/removal from storage/stock transfer. The warehouse manager optionally can subcontract with a logistics service to deliver the goods if he wants to avoid those activities. As a warehouse manager, the holder of the goods is not the owner of the goods and relieves the owner of the goods of the responsibilities of the activities associated with holding the goods. By outsourcing warehouse management, the owner of the goods is beneficially able to focus on core competencies and saves on warehousing costs. The warehouse manager benefits because in these management scenarios, no specific sector know-how is necessary to handle the goods in the warehouse and the warehouse manager can manage goods for numerous companies.

Another warehouse scenario in which the fulfillment coordination engine can be used is in a central warehouse used in retailing, and in particular in food retailing, where the engine is used to manage handling of goods in central warehouses. In general, the engine is used when delivering goods from central warehouses (i.e., warehouses with a full range of products) and individual warehouses (i.e., warehouses with partial product ranges) to multiple stores (e.g., supermarkets and retailers). The characteristics of central warehouses make application of the fulfillment coordination engine beneficial. These characteristics may include one or more of the following: (1) the goods may be perishable; (2) a high turnover rate of goods (e.g., 30,000-60,000 handling units per day, deliveries made 6 days per week); (3) peak times (e.g., 80% of the daily goods receipt within 2 hour period, 60% of the day's quantity picked 3 hours after orders have been received); (4) remote data transfer; (5) a high percentage of articles of weight that must be weighed; (6) shipment control using various dispatch methods (e.g., direct delivery to customer, or dispatch to regional warehouse for final distribution to customer); (7) vehicle fleet management; (8) transfer orders go to fork-lift control when a load carrier is entered; (9) likely to encounter returns (i.e., need loading equipment, empties, goods returns); (10) stock transfer capabilities (if required, direct replenishment, reserve put-away); (11) various picking methods can be used (e.g., individual picking, parallel picking, multi order picking); and (12) simultaneous business data entry.

The fulfillment coordination engine also can be used to coordinate the logistics of fast- and slow-moving items in a cross-docking warehouse scenario, such as a retail warehouse service in which the engine coordinates the movement of goods from the vendor to the retailer's store. This scenario is a variation of the pull warehouse scenario, described above, as applied to retail businesses. In particular, this scenario includes situations in which there is a large assortment of goods and it is not worth warehousing all the goods in every warehouse. The goods are stored in two types of warehouses: a fast-moving item warehouse and a slow-moving item warehouse. The fast-moving item warehouse is used to hold articles that sell quickly. Re-ordering of extra items for the fast-moving item warehouse is made the evening before the following morning in which they are needed. The slow-moving item warehouse is used to hold articles that do not sell as quickly. Re-ordering of extra items for the slow-moving warehouse is made up to the midday before the following morning. The cross-docking scenario involves using containers that have been pre-picked for individual stores from the slow-moving item warehouse. Then, the slow-moving and fast-moving item containers are delivered to the store together in a single delivery. The individual stores order all articles together from an organizing facility. A benefit of using the fulfillment coordination engine in this scenario is that there can be an optimization of routes from the slow-moving item warehouses to the fast-moving item warehouses, and from the fast-moving item warehouses to the stores. Another benefit is the optimization of the delivery to the store by using only one delivery for all the goods to each store. In addition, allocation of articles to the warehouses can be beneficially optimized to reduce inventory costs.

The fulfillment coordination engine can be used for cross-docking delivery of goods for a warehouse service that manages retail goods by providing outbound delivery of the goods from the vendor to the retailer's store. In cross-docking, the goods are delivered directly to the point of sale, such as a retailer's shelf. In the warehouse, the goods are received, sorted, and sent to the retailer without being stored in the warehouse. For example, the engine can be used to manage the logistics where multiple warehouses and vendors deliver to a store, but the store desires a single daily delivery. The engine also can be used to manage the logistics of the cross-docking of single article vendor and retail warehouse pallets, pre-picked retailer and vendor warehouse pallets/containers, and flow-through of handling units from inbound pallets to outbound containers for the stores. In one implementation, the logistics is controlled by the engine by having the warehouse platform that receives the goods being empty at night, using inbound deliveries of goods from other warehouses in the morning, and outbound delivery of goods to the retailers in the afternoon. In this manner, the cross-docking warehouse is empty at the end of the day. In this scenario, the engine is used to optimize the routes from warehouses or vendors that supply the goods to the cross-docking platforms, as well as optimize the routes from the cross-docking platforms to the retailers' stores. Retailers will benefit because there will be only one delivery per store and the delivery will be consolidated. Moreover, the retailer will have faster lead times for ordering goods because the goods arrive at the cross-docking warehouse every morning and are supplied to the retailer that day.

In flow-through delivery, large shipments of goods are broken into smaller units before they are assigned to a particular recipient at a repacking zone. In the repacking zone, the goods are repacked for immediate outbound processing. Flow-through delivery is useful when, for example, a recipient is to receive only half a pallet. The fulfillment coordination engine can be used in flow-through delivery of a warehouse service and has particular applicability in apparel and imported products, where a large shipment may consist of numerous articles of a single item that are unlikely to be required by a retailer in such quantities. The engine is advantageously used when deliveries are made directly to stores from a distribution center rather than a warehouse and there is only one delivery per store. In flow-through delivery, there generally is a fast lead time in the distribution center with immediate picking without put-away. There also may be a two-step picking in the slow-moving item, fast-moving item scenario (e.g., slow-moving items and fast-moving items are picked and packaged in different manners). Using the fulfillment coordination engine in this scenario allows part of the inbound goods to be put away in a buffer storage location. Thus, the goods on a pallet can be divided into goods that are included in an outbound delivery and goods that are assigned to a buffer storage location. An outbound container/shipment also can contain normal goods for a standard warehouse or buffer storage location. There may be a frequent use of materials handling technology and sorting technology. For example, man-to-goods (i.e., position the sorter near the goods) or goods-to-man (i.e., bring the goods to the sorter) sorting is possible using the engine. The sorting and handling may be such that goods both enter and leave the warehouse within the same operation on the same workday. The sorting and handling also can include value added services, such as price marking of the goods to eliminate that step from the responsibilities of the stores. Using the engine in these scenarios allows optimization of automation. Other benefits include a consolidation of goods such that there is only one delivery per store, use of just a few process steps such that there are fast lead times, and a low level of warehouse stock in a buffer storage location.

Although the fulfillment coordination engine can be used for coordinating and controlling the flow of goods between warehouses, retailers, vendors, and logistics services, the engine also can be used to handle the billing associated with the flow of those goods. For example, the engine can be used to handle internal billing within a company for the transfer of goods between a company's warehouse and one or more of the company's vendor, retailer, or store location. Each of these locations for which billing is settled is legally part of the company that owns or controls the warehouse. The engine is also useful where only one internal billing is made between the warehouse and the store, vendor, or retailer. Characteristics of this situation are that ordering is usually made through a retailer's organizational unit (OrgUnit) service and the store does not usually know the purchase prices being charged for the goods. The invoice verification is maintained in a retailer's OrgUnit service rather that in the store and is based on the delivery note dates from the vendor.

The engine also can be used to handle billing between legally independent stores, such as between a warehouse and legally separate vendors, retailers, and stores. The vendor, retailer or store may be a legally separate subsidiary, franchise, or independent retailer. In settling the billing, the engine causes an invoice to flow between the warehouse and the entity being billed (i.e., vendor, retailer, store). In general, ordering is usually done through a retailer's OrgUnit and the ordering store knows the purchase prices (although possibly not all of the terms and write-off of uncollectible receivables). Verification of the invoice is possible in either the retailer's OrgUnit or in the store or both.

The engine also can be used as part of a consultant's solution to an individual logistics solution for a large sender of goods. In such a scenario, the engine can be used where the solution would otherwise be complicated, error-prone, and subject to lengthy project planning. Such an individual solution for a particular customer would provide optimal support of the customer's processes.

A fulfillment coordination engine, as described above, can be used to provide an extended or distributed order management functionality. On the broadest level, an extended order management functionality is used to control the flow of documents and information necessary to fulfill a customer's order. The functionality should be able to fulfill an order under a variety of common corporate situations with multi-channel strategies and multiple back end systems. For example, the order may need to be fulfilled for a company or by a company that is in the midst of a merger or acquisition. The company may have the corporate philosophy that order fulfillment must be controlled based on using the core competencies of partners and internal divisions of the company or that outsourcing should be used where necessary or desirable. The company may structure its order fulfillment and order management based on a customer-centric supply chain that responds to the customers needs, whether they are for just-in-time delivery, inventory management, or a seasonal supply model. In fulfilling the order, the company must be fast and reliable, yet profitable.

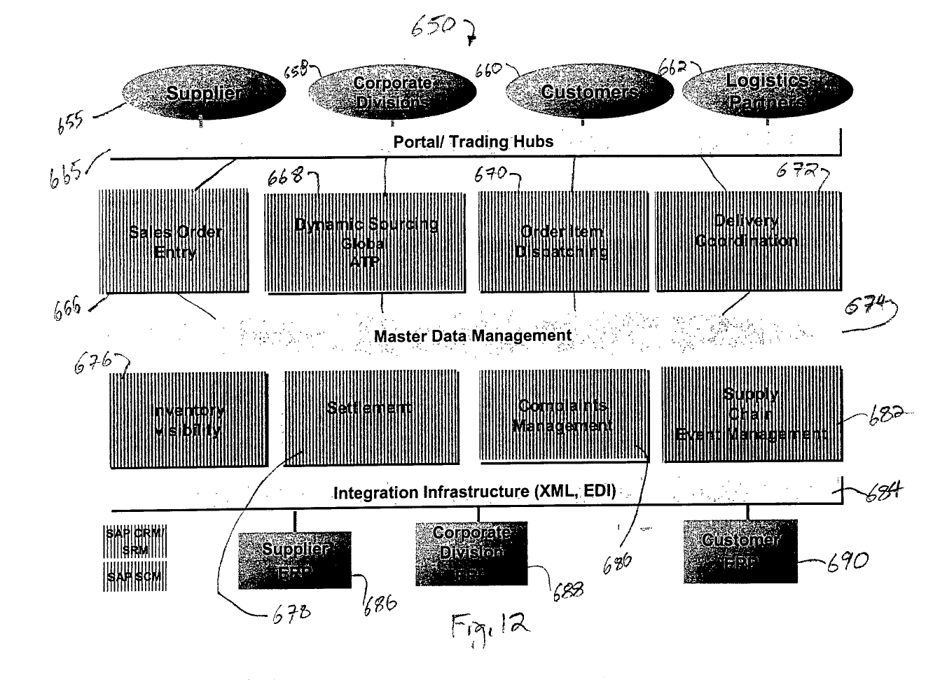

Referring to FIG. 11, as part of a distributed order management scenario 600, a fulfillment coordination engine 603 can be used by a company with existing business applications, such as SAP's Customer Relationship Management (CRM) 605, Financials (FIN) 607, Supplier Relationship Management (SRM) 609, Supply Chain Management (SCM) 611, and Advanced Planner and Optimizer (APO) 613. The combination of these business software applications and the fulfillment coordination engine 603 provides communications with customers 614 and partners. For example, the company uses the CRM software 605 to provide multi-channel order management, marketing campaign management, and customer service management; the FIN software 607 to provide credit checks, bill presentation and payment, and accounting; the SRM software 609 to provide strategic sourcing, dynamic pricing, and purchase order management; and the SCM software 611 to provide adaptive supply chain networks that bridge network processes, such as the customer and supplier relationships. Amongst other features, the fulfillment coordination engine allows the company to provide the documents and information necessary 615 to handle and control these tasks.

The distributed order management scenario 600 is useful for typical business scenarios that include a business process flow that consists of sequentially-linked processes, runs through several internal departments 620 of an enterprise, and involves one or more external partners 625 from external business enterprises. Using the applications above, a company can develop a view of the market that is based on groups of related business scenarios. For example, the business scenario can be that of selling product from stock, configuring product based on a customer order, providing a service, or indirect selling via resellers. In these scenarios, a distributed order management function of CRM (CRM DOM) can be used with the fulfillment coordination engine, which can be implemented as a function of SAP's SCM application. The CRM DOM is used to solve the fulfillment, execution, and settlement of customer orders, including order capture, execution, administration, and returns management. The CRM DOM also is the central order taking system for multiple sales channels and is integrated with the fulfillment coordination engine for the fulfillment coordination. Thus, the order is placed in CRM DOM and the order is then transferred to and processed by the fulfillment coordination engine to control the logistics fulfillment. For example, the fulfillment coordination engine provides delivery of outbound fulfillment of orders, inbound replenishment, stock transfer of orders, and combined inbound/outbound delivery of orders. These can be provided across warehouse services, transportation services, and value-added services, such as mounting, installing, and packaging.

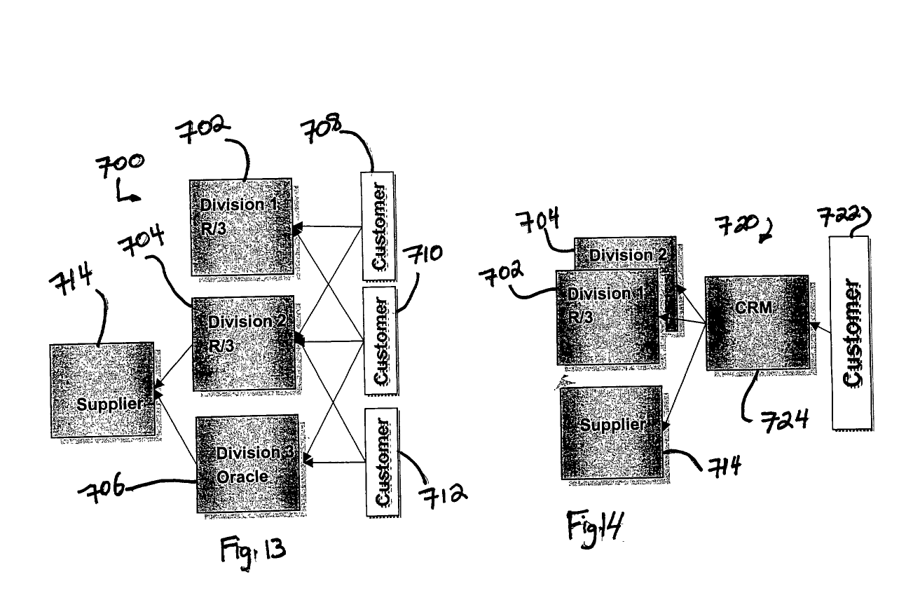

Referring to FIG. 12, an order placed in the distributed order management scenario 600 of FIG. 11 can be fulfilled according to a high level arrangement 650. In the arrangement 650, a supplier 655, one or more corporate divisions 658, customers 660, and logistics partners 662 are interconnected to a portal or trading hub 665. The portal/trading hubs 665 are interconnected to applications, such as SAP CRM, SRM, and SCM, such that certain functionalities are accessed. For example, SCM functionalities include sale order entry 666, dynamic sourcing using global available-to-promise 668, order item dispatching 670, and delivery coordination 672. These applications and functionalities communicate with a master data management system 674. The master data management system 674 communicates with other applications and functionalities, such as SAP CRM and SRM to provide inventory visibility 676 to the customers and partners, settlement of bills and invoices 678, complaints management 680, and supply chain event management 682. The CRM and SRM applications communicate with business applications of external entities through an integration interface 684 based on, for example, XML, EDI, or other interface software. The external entities and their software include the Enterprise Resource Planning (ERP) software 686 of the suppliers, the ERP software 688 of the corporate divisions 688, and the ERP software 690 of the customers.

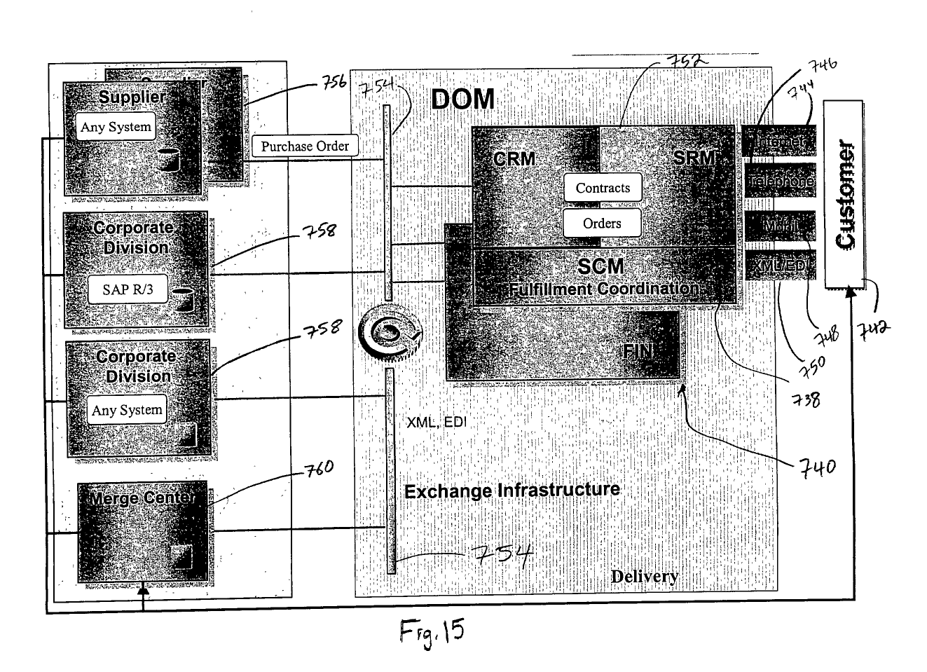

Referring to FIGS. 13 and 14, the fulfillment coordination engine can be used to modify the operation of a business from an enterprise-centric arrangement to a customer-centric arrangement. Specifically, in an enterprise-centric arrangement 700 of FIG. 13, a company has each of its divisions 702, 704, 706 interacting with various customers 708, 710, 712 and suppliers 714. The customers 708, 710, 712, may have various differing relationships with the company. In contrast, as illustrated in FIG. 14, in a customer-centric arrangement 720, the same company can use a fulfillment coordination engine and arrange its relationships with the customers 722 such that the customer has a single, consistent interface with the company, through a CRM application 724. The CRM application uses the fulfillment coordination engine to coordinate order fulfillment with the company's divisions 702, 704 and suppliers 714.

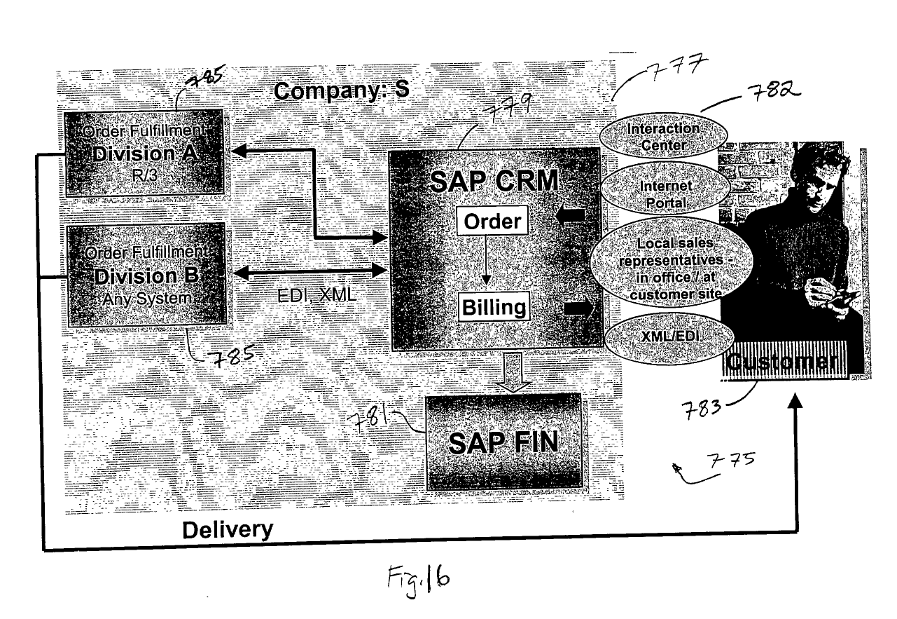

Referring to FIG. 15, a fulfillment coordination engine 738 can be used by a company 740 to implement a distributed order management fulfillment of a customer order. For example, a customer 742 contacts the company 740 using any communications means, such as by an Internet connection 744, a telephone connection 746, a mobile connection 748, or with an XML or EDI document 750. The company 740 may be using one or more software applications 752, such as SAP's CRM, SRM, FIN, and SCM, described above. The customer order is processed by the applications 752 and the tasks necessary to complete the order are determined by the fulfillment coordination engine 738. The fulfillment coordination engine 738 then creates orders and contracts and distributes the orders and contracts through an exchange infrastructure 754 to one or more suppliers 756, one or more corporate divisions 758, and a merge center 760. The orders and contracts may be in the form of work packages. The suppliers 756, the corporate divisions 758, and the merge center 760 may be running any ERP system, including SAP's R/3. The exchange infrastructure 754 is programmed and has the capabilities to communicate with any ERP system, for example, by communicating in XML and/or EDI. The suppliers 756 and corporate divisions 758 fulfill the order and the merge center 760 compiles the order so that it can be delivered to the customer 742. The merge center 760 can be one of the warehouses or distribution centers described above.

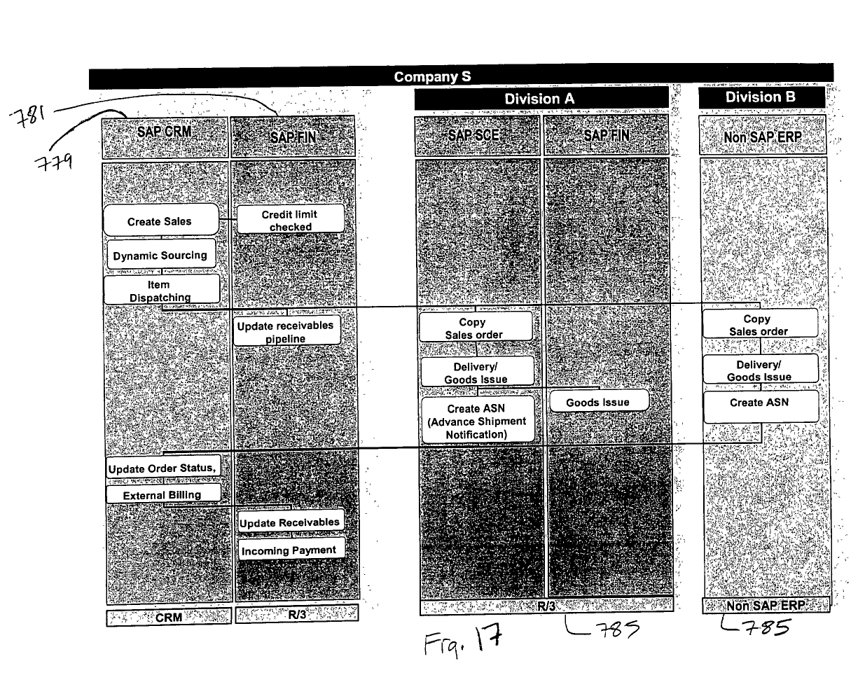

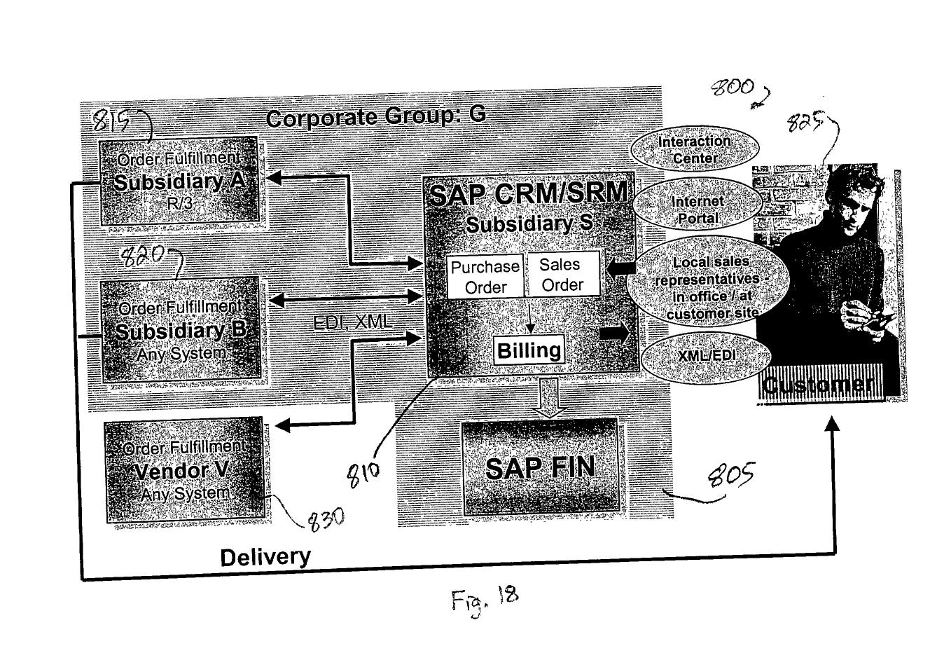

An existing DOM system of a company can be upgraded to use the fulfillment coordination engines described herein. For example, referring to FIGS. 16 and 17, an existing intra-company DOM system 775 of a company 777 includes applications such as SAP CRM 779 and SAP FIN 781. The SAP CRM application 779 receives a customer order 782 from a customer 783 through an interaction center, Internet portal, local sales representative, or by an XML or EDI document. The order 782 is forwarded to one or more corporate divisions 785 for fulfillment of the order and delivery to the customer. When the order is initially received from the customer 783, the CRM application 779 creates a sales event, performs dynamic sourcing, and item dispatching. The CRM application 779 also contacts the FIN application 781 to perform a credit limit check prior to initiating work for the customer 783 and, assuming that the credit limit is acceptable, the FIN application 781 updates a receivables pipeline. To start fulfilling the order, the CRM application 779 sends a sales order to the divisions 785 of the company 777 that will fulfill the order. The divisions 785 then deliver or issue the goods and create an advanced shipment notification to the CRM application 779, which updates the order status and produces an external billing invoice. The FIN application 781 updates the receivables ledger to account for an incoming payment in response to the external billing invoice.

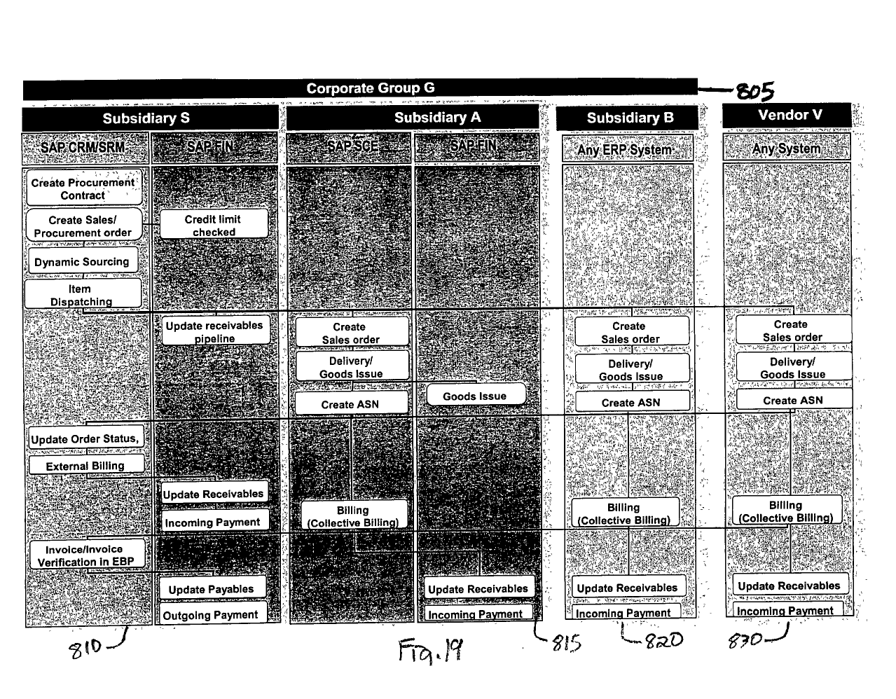

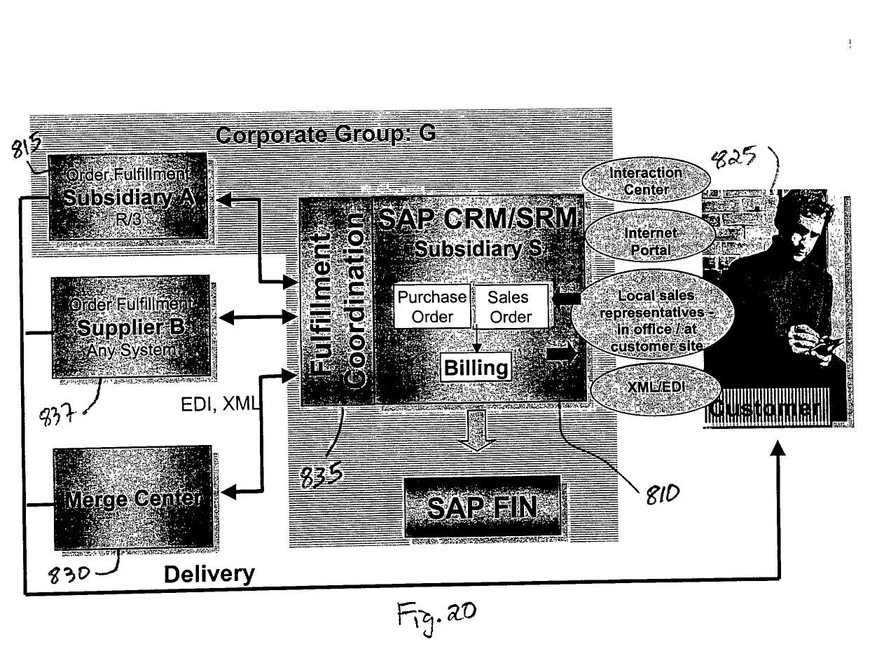

Referring to FIGS. 18 and 19, a DOM system also can be implemented in an intra-enterprise scenario 800 in which a corporate group 805 includes a first subsidiary 810, a second subsidiary 815, and a third subsidiary 820. The first subsidiary 810 operates one or more applications, such as CRM, SRM, and FIN. The first subsidiary 810 receives an order from a customer 825 in a manner as described above for FIG. 16, prepares purchase, procurement, and sales orders, and billing information, and conducts dynamic sourcing for fulfilling the order. To fulfill the order, the first subsidiary sends sales and procurement orders to the second subsidiary 815, the third subsidiary 820, and a vendor 830. The sales and procurement orders may be XML or EDI documents that can be understood by any ERP system used by the subsidiaries and vendor. When the order is fulfilled, the resulting goods are delivered to the customer 825.

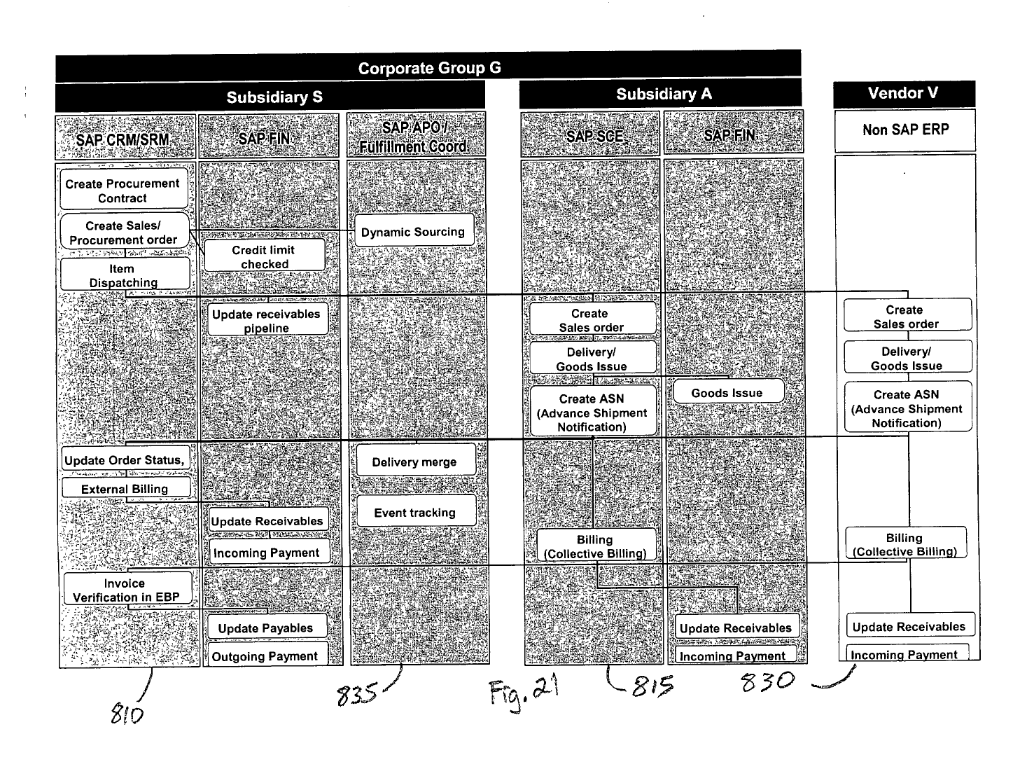

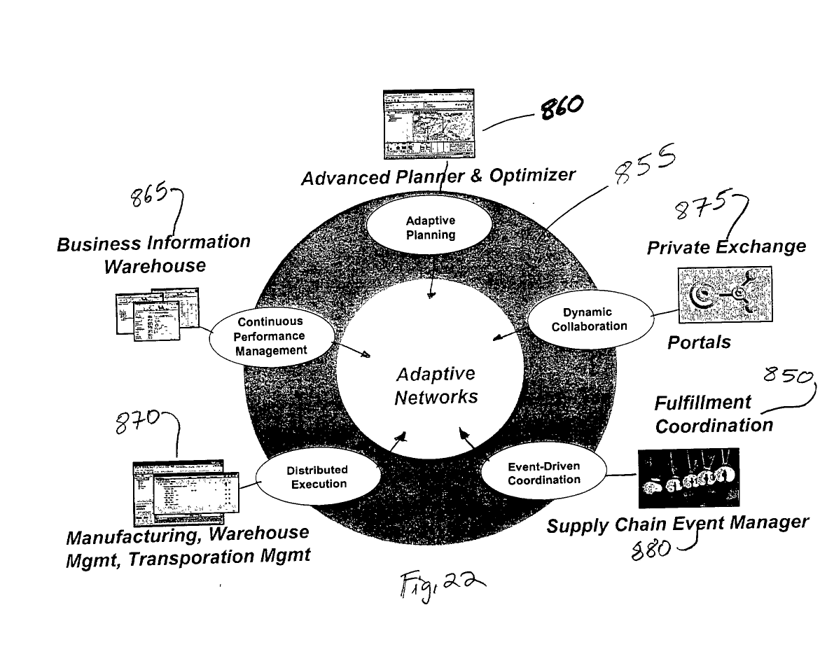

Referring to FIGS. 20 and 21, a fulfillment coordination engine 835 as described herein can be implemented in the DOM system of FIGS. 18 and 19 and replace some of the functionality originally handled by other software applications, such as SAP's CRM/SRM. For example, the first subsidiary 810 of the corporate group 805 can use the fulfillment coordination engine 835 in combination with applications, such as SAP's CRM, SRM, and FIN. The fulfillment coordination engine 835 takes over the dynamic sourcing function of CRM/SRM applications to implement DOM and uses the various functions described above to optimize the sourcing. A supplier 837 can replace the subsidiary 820 to fulfill the order without complicating the order fulfillment. Similarly, a merge center 838 can replace the vendor 830. In other respects, order fulfillment using the fulfillment coordination engine 835 does not change the operation of DOM with respect to an observer viewing the system. However, using the engine 835 provides considerable advantages. For example, the engine 835 coordinates a dynamic DOM across an adaptive network. As such, the engine provides the ability to integrate a multi-channel order management environment, such as SAP's CRM, with a central service to coordinate the fulfillment process across different sites and partners, including order promising, transportation coordination, valued added service management, cost management, and document management. Moreover, the engine 835 does not detract from the benefits of DOM. For example, combining DOM and the fulfillment coordination engine provides a single face to the customer through simplified order processing, standardized pricing, and consolidated invoices. The order is visible throughout the entire lifecycle and across multiple enterprises. Moreover, customers, suppliers, and trading partners have real-time access to determine order status. The combination of DOM and the engine also protect and optimize the investments made in traditional enterprise technologies because they are readily adaptable to changes in the supply network, including adding a new supplier and selling third party products from inventory stock held by suppliers. There also is no need to harmonize master data because the exchange interfaces are capable of handling multiple communication and data formats. The DOM and the engine also increase procurement efficiency. For example, they reduce procurement costs due to automatic ordering because the purchase order data is created automatically from the order data. They also increase procurement efficiency by accelerating purchase transactions by automatically transferring the purchase orders to vendors in an electronic format. The orders are brokered automatically using rule-based brokering.

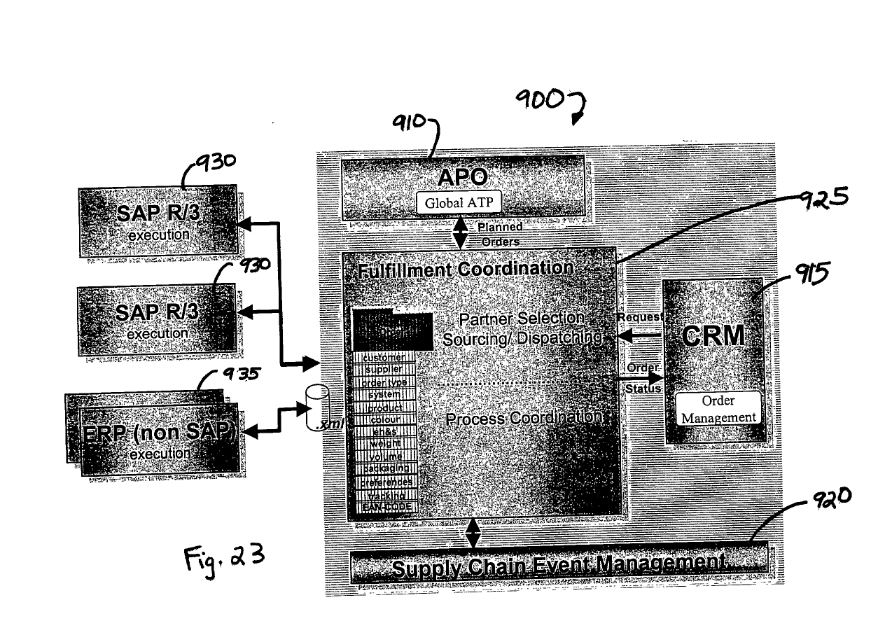

Referring to FIG. 22, in another implementation, a fulfillment coordination engine 850 can be a component of an adaptive supply chain network 855 that includes an advanced planner and optimizer (APO) application 860, a business information warehouse application 865, a manufacturing, warehouse management, and transportation management application 870, a private exchange or portal 875, and a supply chain event manager application 880. The APO application 860 provides adaptive planning to the supply chain. The business information warehouse application 865 provides continuous performance management to the supply chain by, for example, monitoring the supply chain. The manufacturing, warehouse management, and transportation management application 870 controls a distributed execution process for fulfilling an order. The private exchange or portal 875 is used for dynamic collaboration between customers, corporations, suppliers, and vendors. The supply chain event manager application 880, which includes the fulfillment coordination engine 850, provides event driven coordination of the order fulfillment.

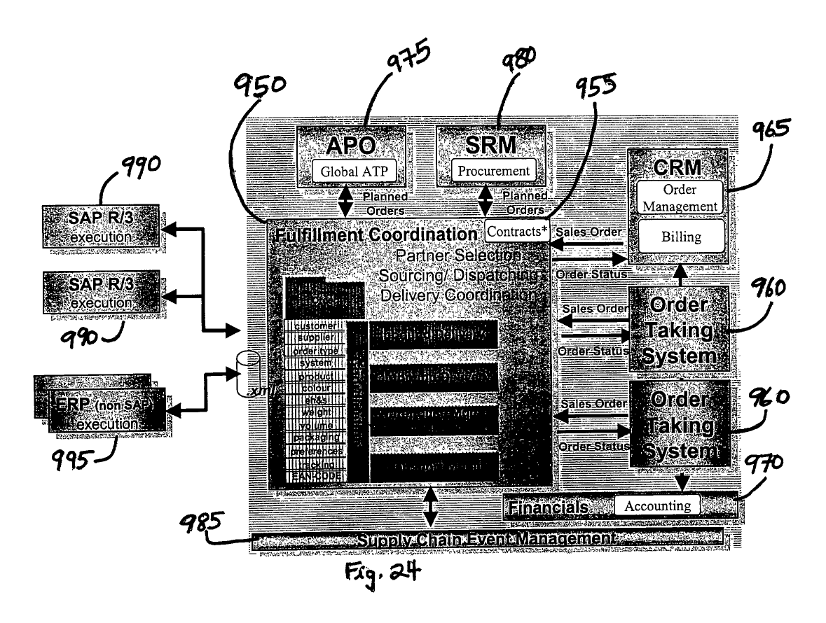

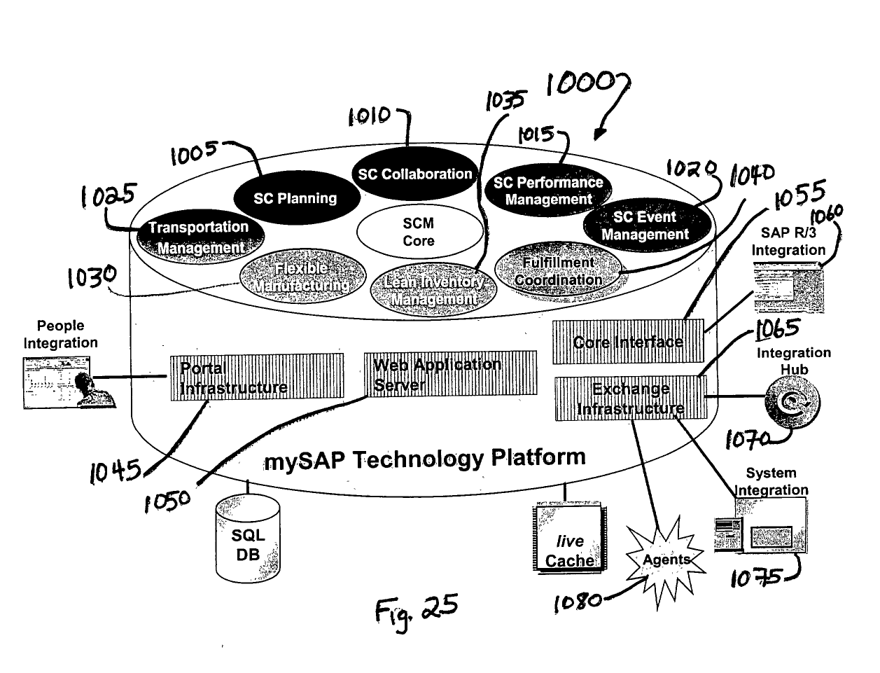

Referring to FIGS. 23 and 24, the fulfillment coordination engine can be implemented as part of a corporate system for order fulfillment. FIG. 23 illustrates a corporate system 900 that includes a computer-implemented system 905 that operates an APO application 910, a CRM application 915, a supply chain event management application 920, and a fulfillment coordination engine 925. The CRM application 915 receives a customer order and transfers it to the fulfillment coordination engine 925. The order may include variables, such as customer information, supplier, order type, system, product, color, weight, volume, packaging, preferences, and tracking. The fulfillment coordination engine 925 performs partner selection, sourcing, dispatching, and process coordination, and sends an order status to the CRM application 915. The engine 925 also communicates with the supply chain event management application 920 and the APO application 910. To fulfill the order, the fulfillment coordination engine also communicates with the ERP applications of internal divisions 930 and external organizations 935 using XML or other suitable protocol. The ERP applications can be, for example, SAP ERP applications.

FIG. 24 illustrates a scenario in which a company running a fulfillment coordination engine 950 operates the engine as part of a central system 955 that receives orders from multiple order taking systems 960. The order taking systems 960 communicate with and transfer information to a CRM application 965, a financial application 970, and the fulfillment coordination engine 950. The fulfillment coordination engine 950 performs partner selection, sourcing, dispatching, and delivery coordination and sends an order status to the CRM application and the order taking systems. The engine 950 also coordinates inbound and outbound deliveries, warehouse management, value added services, and transport management. The engine 950 also sends information about planned orders to an APO application 975 and a SRM application 980, and fulfillment coordination information to a supply chain event management application 985. To fulfill the order, the fulfillment coordination engine 950 also communicates with the ERP applications of internal partners 990 and external partners 995 using XML or other suitable protocol. The ERP applications can be, for example, SAP ERP applications. The partners used to fulfill the order can be arbitrary partners. The engine also can be used to direct shipments to customers through the partners, and provide stock transfers to dedicated partners.

A number of embodiments of the invention have been described. Nevertheless, it will be understood that various modifications may be made without departing from the spirit and scope of the invention. For example, referring to FIG. 25, in one particular configuration a single supply chain management system 1000 is used to direct networking, planning, coordination, and execution. The system 1000 includes applications, such as supply chain planning 1005, supply chain collaboration 1010, supply chain performance management 1015, supply chain event management 1020, transportation management 1025, flexible manufacturing 1030, lean inventory management 1035, and fulfillment coordination 1040. A portal infrastructure 1045 and a web application server 1050 are used to communicate with the system 1000. A core interface 1055 is used to communicate with an ERP application 1060 and an exchange infrastructure 1065 is used to communicate with an integration hub 1070, a system integration system 1075, and agents 1080.

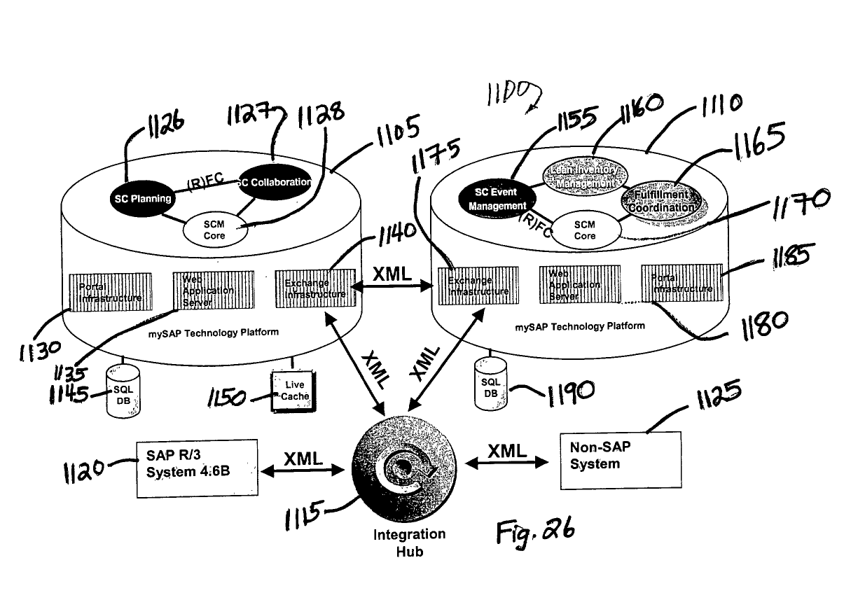

Referring to FIG. 26, in another particular configuration a system 1100 includes message-based integration and uses communication of building blocks via function calls. However, the integration is not based on a database. A supply chain planning building block 1105 communicates with the fulfillment coordination engine 1110 and an integration hub 1115. The hub 1115 communicates with, for example, a SAP ERP application 1120 and a non-SAP ERP application 1125. The supply chain planning building block 1105 includes functions such as supply chain planning 1126, supply chain collaboration 1127, and a supply chain management core 1128. The block 1105 also includes a portal infrastructure 1130, a web application server 1135, and an exchange infrastructure 1140 that communicate with a SQL database 1145 and a live cache 1150. The fulfillment coordination engine 1110 includes functions such as supply chain event management 1155, lean inventory management 1160, fulfillment coordination 1165, and a supply chain management core 1170. The engine also includes an exchange infrastructure 1175, a web application server 1180, and a portal infrastructure 1185 that communicate with a SQL database 1190. The supply chain planning building block, fulfillment coordination engine and the integration hub communicate with each other using XML, or other similar protocol.

The portals described herein may have, for example, a user-centric collaboration, unification of underlying sources for seamless navigation, and device independence technology for presentation. The applications may have, for example, web service provisions, open standards-based connectivity through native Web technology, and platform independent infrastructure. The exchanges may have, for example, process-centric collaboration, common business process semantics for seamless integration, and application-independent business process collaboration.

Accordingly, other embodiments are within the scope of the following claims.

What is claimed is:

1. A method of coordinating the fulfillment of an order, the method comprising:
receiving an order;
using a first set of rules to split the order into one or more work packages necessary to fulfill the order; and
using a second set of rules to assign the work packages to one or more partners.

2. The method of claim 1, wherein the first set of rules breaks the order into one or more work packages based on the locations of goods necessary to fulfill the order.

3. The method of claim 1, wherein the first set of rules breaks the order into one or more work packages based on the locations in which the order is to be fulfilled.

4. The method of claim 1, further comprising consolidating goods by obtaining goods from each of the partners to which a work package is assigned.

5. The method of claim 4, further comprising shipping the consolidated goods to the sender of the order.

6. The method of claim 1, further comprising receiving a notification from one or more of the partners.

7. The method of claim 6, wherein receiving a notification comprises receiving a notification of one or more of a shipping notification and a transport notification.

8. The method of claim 1, further comprising a receipt of goods when the order comprises an inbound delivery.

9. The method of claim 8, further comprising providing data to one or more of a warehouse management system and an inventory management system.

10. The method of claim 1, further comprising calculating a logistics cost of fulfilling the order.

11. An article comprising a computer-readable medium that stores executable instructions for causing a computer system to:
receive an order;
use a first set of rules to split the order into one or more work packages necessary to fulfill the order; and
use a second set of rules to assign the work packages to one or more partners.

12. The article of claim 11, wherein the first set of rules comprises instructions to break the order into one or more work packages based on the locations of goods necessary to fulfill the order.

13. The article of claim 11, wherein the first set of rules comprises instructions to break the order into one or more work packages based on the locations in which the order is to be fulfilled.

14. The article of claim 11, further comprising executable instructions for causing the computer system to cause a consolidation of goods by obtaining goods from each of the partners to which a work package is assigned.

15. The article of claim 14, further comprising executable instructions for causing the computer system to cause the shipping of the consolidated goods to the sender of the order.

16. The article of claim 11, further comprising executable instructions for causing the computer system to receive a notification from one or more of the partners.

17. The article of claim 16, wherein the notification comprises one or more of a shipping notification and a transport notification.

18. The article of claim 11, further comprising executable instructions for causing the computer system to provide a receipt of goods when the order comprises an inbound delivery.

19. The article of claim 18, further comprising executable instructions for causing the computer system to provide data to one or more of a warehouse management system and an inventory management system.

20. The article of claim 11, further comprising executable instructions for causing the computer system to calculate a logistics cost of fulfilling the order.

21. A system comprising one or more computer systems and a fulfillment coordination computer coupled to the computer systems over a network, the fulfillment coordination computer being operable to:
receive an order;
use a first set of rules to split the order into one or more work packages necessary to fulfill the order; and
use a second set of rules to assign the work packages to one or more partners.

22. The system of claim 21, wherein the first set of rules comprises instructions to break the order into one or more work packages based on the locations of goods necessary to fulfill the order.

23. The system of claim 21, wherein the first set of rules comprises instructions to break the order into one or more work packages based on the locations in which the order is to be fulfilled.

24. The system of claim 21, further comprising executable instructions to cause a consolidation of goods by obtaining goods from each of the partners to which a work package is assigned.

25. The system of claim 24, further comprising executable instructions for causing the shipping of the consolidated goods to the sender of the order.

26. The system of claim 21, further comprising executable instructions for causing the fulfillment coordination computer to receive a notification from one or more of the partners.

27. The system of claim 26, wherein the notification comprises one or more of a shipping notification and a transport notification.

28. The system of claim 21, further comprising executable instructions for causing the fulfillment coordination computer to provide a receipt of goods when the order comprises an inbound delivery.

29. The system of claim 28, further comprising executable instructions for causing the computer to provide data to one or more of a warehouse management system and an inventory management system.

30. The system of claim 21, further comprising executable instructions for causing the fulfillment coordination computer to calculate a logistics cost of fulfilling the order.
